(19) United States
(12) Patent Application Publication
(10) Pub. No.: US 2025/0297419 A1
(43) Pub. Date: Sep. 25, 2025

(54) HOME APPLIANCE AND METHOD FOR OPERATING THE SAME

(71) Applicant: SAMSUNG ELECTRONICS CO., LTD., Suwon-si (KR)

(72) Inventors: Nokhaeng LEE, Suwon-si (KR); Daekee KIM, Suwon-si (KR); Hooijoong KIM, Suwon-si (KR); Incheol LEE, Suwon-si (KR); Sung HAN, Suwon-si (KR)

(73) Assignee: SAMSUNG ELECTRONICS CO., LTD., Suwon-si (KR)

(21) Appl. No.: 19/081,741

(22) Filed: Mar. 17, 2025

Related U.S. Application Data
(63) Continuation of application No. PCT/KR2025/003100, filed on Mar. 10, 2025.

(30) Foreign Application Priority Data
Mar. 25, 2024 (KR) 10-2024-0040595

(51) Int. Cl. D06F 34/14; D06F 34/05; D06F 34/08

(52) U.S. Cl. CPC D06F 34/14; D06F 34/05; D06F 34/08

(57) ABSTRACT

A home appliance including a first sensor, a second sensor, and at least one processor that executes instructions to obtain, using the first sensor, a first sound signal including a signal corresponding to an operation sound generated inside the home appliance and a signal corresponding to an external sound generated outside the home appliance, obtain, using the second sensor, a second sound signal including a signal having a correlation with the signal corresponding to the external sound included in the first sound signal, generate a third sound signal by performing pre-processing on the first sound signal and the second sound signal using an adaptive filter, and obtain data related to a status of the home appliance based on the third sound signal. A filter coefficient of the adaptive filter may be updated using an adaptive algorithm based on the third sound signal and the second sound signal.

### CROSS-REFERENCE TO RELATED APPLICATIONS

This application is a continuation application of International Application No. PCT/KR2025/003100 designating the United States, filed on Mar. 10, 2025, in the Korean Intellectual Property Receiving Office, which claims priority from Korean Patent Application No. 10-2024-0040595, filed on Mar. 25, 2024, in the Korean Intellectual Property Office, the disclosures of which are hereby incorporated by reference herein in their entireties.

### BACKGROUND

### Field

The disclosure relates to a home appliance and a method for operating the same.

### Description of Related Art

There are a variety of methods that may be used to diagnose the status of a home appliance. One of the methods may be a technology for diagnosing abnormal statuses of home appliances using sound data obtained by measuring an operation sound generated inside the home appliance by a separate user device (e.g., a mobile phone) located outside the home appliance.

Since the diagnostic technology may not constantly measure the operation sound of the home appliance, the user is required to measure the operation sound of the home appliance again by operating the home appliance after identifying an abnormality in the home appliance. In this case, it may be difficult to reproduce the operation sound corresponding to the abnormality sound, making precise status diagnosis tricky. Further, since external noise together with the operation sound of the home appliance is measured by the user device depending on the position where the user places the user device and the environment of the space where the home appliance is installed, it may be hard to accurately diagnose the status of the home appliance using the measured sound data.

### SUMMARY

The disclosure provides a method for diagnosing a status of a home appliance using a sound signal detected by a plurality of sensors included in the home appliance.

The disclosure provides a method for diagnosing a status of a home appliance by pre-processing a sound signal detected by a plurality of sensors included in the home appliance using at least one filter and by using the pre-processed sound signal.

The disclosure provides a method by which a home appliance cooperates with an external electronic device (e.g., a server) to diagnose a status of the home appliance.

A home appliance according to an embodiment of the disclosure may include a first sensor for detecting a sound, a second sensor for detecting a sound, memory including at least one storage medium storing instructions, and at least one processor including a processing circuit. The at least one processor may be configured to execute the instructions to obtain a first sound signal using the first sensor, the first sound signal including a signal corresponding to an operation sound generated inside of the home appliance and a signal corresponding to an external sound generated outside of the home appliance, obtain a second sound signal using the second sensor, the second sound signal including a signal having a correlation with the signal corresponding to the external sound generated outside of the home appliance included in the first sound signal, generate a third sound signal by performing processing on the first sound signal and the second sound signal and using an adaptive filter with an input that is based on at least one of the first sound signal and the second sound signal, obtain data related to a status of the home appliance based on the third sound signal. A filter coefficient of the adaptive filter may be updated using an adaptive algorithm based on the third sound signal and the second sound signal.

In a method for operating a home appliance according to an embodiment of the disclosure, the home appliance may include a first sensor for detecting a sound and a second sensor for detecting a sound. The method may include obtaining, using the first sensor, a first sound signal including a signal corresponding to an operation sound generated inside of the home appliance and a signal corresponding to an external sound generated outside of the home appliance, obtaining, using the second sensor, a second sound signal including a signal having a correlation with the signal corresponding to the external sound generated outside of the home appliance included in the first sound signal, generating a third sound signal by performing processing on the first sound signal and the second sound signal and using an adaptive filter with an input that is based on at least one of the first sound signal and the second sound signal, obtaining data related to a status of the home appliance based on the third sound signal. A filter coefficient of the adaptive filter may be updated using an adaptive algorithm based on the third sound signal and the second sound signal.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an outer appearance of a washer according to an embodiment of the disclosure;

FIG. 2 is a side cross-sectional view illustrating a washer according to an embodiment of the disclosure;

FIG. 3 is a functional block diagram schematically illustrating a configuration of a washer according to an embodiment of the disclosure in terms of functions and controls;

FIG. 4 is a view illustrating an example configuration of a home appliance according to an embodiment of the disclosure;

FIG. 5 illustrates an example configuration of a pre-processing module according to an embodiment of the disclosure;

FIG. 6 illustrates an example configuration of a pre-processing module according to an embodiment of the disclosure;

FIG. 7 illustrates an example configuration of a pre-processing module according to an embodiment of the disclosure;

FIG. 8 illustrates a sensor assembly and an arrangement structure of the sensor assembly according to an embodiment of the disclosure;

FIG. 9 illustrates a sensor assembly and an arrangement structure of the sensor assembly according to an embodiment of the disclosure;

FIG. 10 illustrates a sensor assembly and an arrangement structure of the sensor assembly according to an embodiment of the disclosure;

FIG. 11 illustrates an example configuration of a main-processing module according to an embodiment of the disclosure;

FIG. 12 illustrates an example configuration of a main-processing module according to an embodiment of the disclosure;

FIG. 13 is a flowchart illustrating a method for operating a home appliance according to an embodiment of the disclosure;

FIG. 14 is a signal flowchart illustrating a procedure for diagnosing a status of a home appliance according to an embodiment of the disclosure;

FIG. 15 is a signal flowchart illustrating a procedure for diagnosing a status of a home appliance according to an embodiment of the disclosure;

FIG. 16 is a signal flowchart illustrating a pre-processing procedure of a home appliance according to an embodiment of the disclosure;

FIG. 17 is a flowchart illustrating a pre-processing operation of a home appliance according to an embodiment of the disclosure;

FIG. 18 is a flowchart illustrating a pre-processing operation of a home appliance according to an embodiment of the disclosure;

FIG. 19 illustrates an example configuration of a home appliance according to an embodiment of the disclosure;

FIG. 20 illustrates an example configuration of a server according to an embodiment of the disclosure;

FIG. 21A illustrates an arrangement structure of a sensor assembly of a home appliance according to an embodiment of the disclosure;

FIG. 21B is a front perspective view illustrating a sensor assembly according to an embodiment of the disclosure;

FIG. 21C is a rear perspective view illustrating a sensor assembly according to an embodiment of the disclosure;

FIG. 22 illustrates an arrangement structure of a sensor assembly of a home appliance according to an embodiment of the disclosure;

FIG. 23 illustrates a result of comparison between sound signals according to an embodiment of the disclosure; and

FIG. 24 illustrates a signal spectrum depending on a status of a home appliance according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

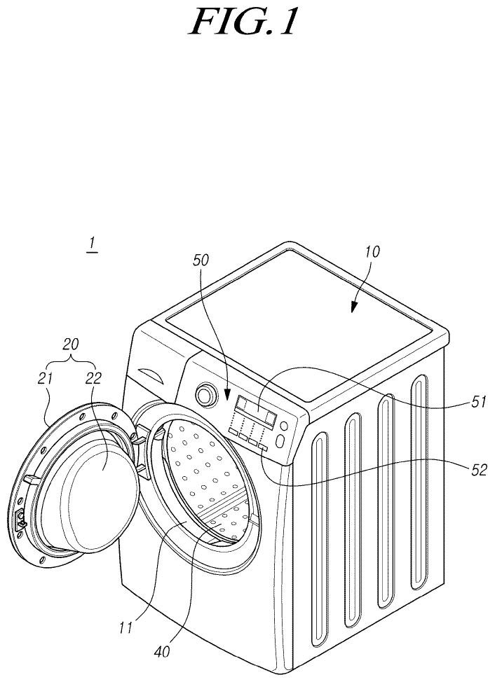

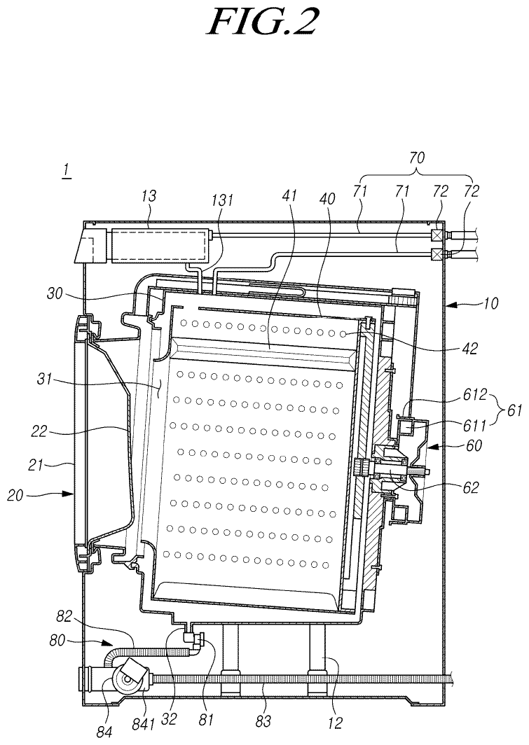

FIG. 1 is a perspective view illustrating an outer appearance of a washer according to an embodiment of the disclosure. FIG. 2 is a side cross-sectional view illustrating a washer according to an embodiment of the disclosure.

In an example, the washer 1 may include a housing 10 for receiving various components therein. The housing 10 may have an overall hexahedral shape. The housing 10 may include an opening formed in one surface thereof. Two or more of the surfaces of the housing 10 may be integrally formed. Each surface of the housing 10 may be separately manufactured and assembled. The housing 10 may be, e.g., press-molded with an iron plate material or injection-molded with a resin material.

In an example, a door 20 for opening and closing the corresponding opening may be provided in a portion corresponding to the opening of the housing 10. The door 20 may be rotatably coupled to a hinge fixed to one surface of the housing 10. For example, at least a portion of the door 20 may be provided to be transparent or translucent so as to be visible inside. The user may open and close the door 20 to put the laundry into the drum 40 positioned inside the housing 10 or withdraw the laundry from the drum 40. For example, the door 20 may be locked by a locking device (not shown) so as not to be opened while the washer 1 is running. In an example, the door 20 may include a door frame 21 and a glass member 22. The glass member 22 may be formed of, e.g., a transparent tempered glass material to see through the inside of the housing 10, but the disclosure is not limited thereto.

In an example, the washer 1 may include a tub 30 fixedly disposed inside the housing 10. The tub 30 may have a substantially cylindrical shape with one side open. A tub opening 31 may be provided in the front surface of the tub 30 at a position corresponding to the opening of the housing 10. The tub 30 may store washing water. A drain port 32 for draining washing water may be provided under the tub 30. The drain port 32 may be connected to, e.g., the drain device 80.

In an example, the washer 1 may include a damper 12. The damper 12 may be provided to connect the housing 10 and the tub 30. One side of the damper 12 may be fixed to the inner surface of the housing 10 and the other side of the damper 12 may be fixed to the tub 30. The damper 12 may be provided to attenuate vibration by absorbing vibration energy transferred to the tub 30 and/or the housing 10 when the drum 40 rotates.

In an example, the washer 1 may include a drum 40 provided inside the tub 30. The drum 40 may have a substantially cylindrical shape with one side open. A front plate and a rear plate may be disposed on the front surface and the rear surface, respectively, of the drum 40. The front plate may be provided with a drum opening at a position corresponding to the opening of the housing 10 and the tub opening 31 of the tub 30. The drum 40 may receive laundry. The drum 40 may receive rotational power from the driving device 60 and rotate inside the tub 30. The drum 40 may perform washing, rinsing, and/or spinning while rotating inside the tub 30.

In an example, the drum 40 may include a lifter 41 and/or a plurality of through holes 42. For example, the lifter 41 may lift the laundry while the drum 40 rotates so that the laundry repeatedly rises and falls, thereby evenly washing laundry on several surfaces thereof. The through hole 42 may be, e.g., a passage formed so that the washing water received in the tub 30 flows into the drum 40 or the washing water inside the drum 40 is discharged to the outside. In an example, the lifter 41 or the through hole 42 may be omitted.

In an example, the washer 1 may include a control panel 50 that supports interaction between the user and the washer 1. In an example, the control panel 50 may be disposed at an upper end of the front surface of the housing 10 as illustrated in FIG. 1, but the disclosure is not limited thereto. In an example, the control panel 50 may include an input unit 51 and a display unit 52.

The input unit 51 may include, e.g., any type of user input means for obtaining a user input for controlling the washer 1. The user may input power on/off, washing setting information (e.g., operation start/stop, course selection, time selection, etc.) of the washer 1 through the input unit 51. For example, the input unit 51 may be a tact switch, a push switch, a slide switch, a toggle switch, a micro switch, or a touch switch, but the disclosure is not limited thereto. For example, the input unit 51 may be in the form of a jog shuttle that the user may grip and rotate. In an example, the input unit 51 may include an infrared sensor. The user may remotely input the setting information through the remote control, and the input setting information may be received by the input unit 51 as an infrared signal. In an example, the input unit 51 may include a microphone. Setting information by the user's voice may be obtained through a microphone.

The display unit 52 may display various washing setting information and/or operation state information about the washer 1 input from the user. The display unit 52 may include various types of display panels such as an LCD, an LED, an OLED, a QLED, and a micro LED. For example, the display unit 52 may be implemented as a touch screen with a touch pad provided on the front surface thereof, but the disclosure is not limited to a specific type of display means. In an example, the display unit 52 may include any type of audio display means including a speaker, and may display each of the above-described information as an auditory signal through the audio display means. In an example, the display unit 52 may operate to audibly provide the user with information for guiding the user's input and/or information related to the ongoing process.

In an example, the washer 1 may include a driving device 60 for rotating the drum 40. The driving device 60 may include a motor 61 and a driving shaft 62 for transferring the driving force generated by the motor 61 to the drum 40. The motor 61 may include a fixed stator 611 and a rotor 612 that rotates by electromagnetically interacting with the stator 611 to convert an electric force into a mechanical rotational force. The rotational force generated by the motor 61 may be transferred to the drum 40 through the driving shaft 62. The driving shaft 62 may be press-fitted into the rotor 612 of the motor 61 to rotate together with the rotor 612. The driving shaft 62 may, e.g., partially penetrate the rear wall of the tub 30 to connect the drum 40 and the motor 61. The driving device 60 may rotate the drum 40 forward or backward to perform washing, rinsing, and/or spinning operations.

In an example, the washer 1 may include a water supply device 70 for supplying washing water to the drum 40 and/or the tub 30. The water supply device 70 may include at least one water supply pipe 71 and at least one water supply valve 72. The at least one water supply pipe 71 may be provided to supply washing water into the tub 30 using an external water supply source. One of the at least one water supply pipe 71 may be connected to a detergent supply device 13 provided in the housing 10. Here, the detergent supply device 13 may be divided into a plurality of spaces, and each space may be provided with a detergent, a rinsing agent, or the like. The washing water passing through the detergent supply device 13 may be supplied to the tub 30 together with the detergent (or rinsing agent) through the detergent supply pipe 131. Another one of the at least one water supply pipe 71 may be directly connected to the tub 30. For example, the washing water supplied through the water supply pipe 71 directly connected to the tub 30 may be directly supplied to the tub 30 without going through an intermediate component such as the detergent supply device 13.

In an example, the washer 1 may include a drain device 80 for draining the washing water received in the drum 40 and/or the tub 30. The drain device 80 may include a drain valve 81, a first drain pipe 82, a second drain pipe 83, or a pump chamber 84. The drain device 80 may be disposed, e.g., under the tub 30 to discharge the washing water discharged from the tub 30 to the outside of the washer 1.

In an example, the drain valve 81 may be provided to open and close the drain port 32. When the drain valve 81 is opened, the washing water received in the tub 30 may flow through the drain port 32 to the drain device 80.

In an example, the first drain pipe 82 and the second drain pipe 83 may form a flow path that guides washing water to be discharged to the outside. For convenience of description, the upper stream of the pump chamber 84 is referred to as the first drain pipe 82 and the lower stream is referred to as the second drain pipe 83. The first drain pipe 82 and the second drain pipe 83 may be integrally formed. The first drain pipe 82 may have, e.g., one end connected to the drain port 32 and the other end connected to the pump chamber 84. The washing water may move into the pump chamber 84 along the first drain pipe 82. The second drain pipe 83 may have, e.g., one end connected to the pump chamber 84 and the other end connected to the outside of the washer 1. Accordingly, the washing water passing through the pump chamber 84 may be discharged to the outside of the washer 1 along the second drain pipe 83.

In an example, the pump chamber 84 may be provided under the tub 30 to store washing water drained from the tub 30. Inside the pump chamber 84, e.g., a drain pump 841 for discharging the stored washing water to the outside may be provided. The washing water pumped by the drain pump 841 may be guided to the outside of the housing 10 through the second drain pipe 83.

According to an embodiment, the washer 1 may include a balancer. The balancer may include, e.g., a balancer housing forming an annular channel and a plurality of mass bodies disposed on the annular channel to perform a balancing function of the drum 40 while moving along the annular channel. The plurality of mass bodies may have, e.g., a ball shape (a spherical shape). The plurality of mass bodies of the drum 40 may move in a direction opposite to the direction of the eccentricity generated in the drum 40 by the laundry when the drum 40 rotates, compensating for the eccentricity generated by the laundry.

According to an embodiment, the balancer may be mounted on at least one of the front plate and the rear plate of the drum 40. Since the balancers mounted on the front plate and the rear plate are entirely the same, the following description focuses primarily on the balancer mounted on the front plate of the drum 40.

According to an embodiment, the balancer may be configured to be received in an annular recess formed as the front plate of the drum 40 is open forward. For example, the balancer housing may be received in the annular recess of the drum 40.

In an example, the balancer housing may be formed of, e.g., a plastic material such as polypropylene or acrylonitrile butadiene styrene (ABS) resin by injection molding. In an example, the balancer housing may be manufactured through a method of coupling in a thermal fusion method.

According to an embodiment, the washer 1 may include a vibration sensor. The vibration sensor may be disposed on an outer circumferential surface of the drum 40 to sense vibration of the drum 40. For example, the vibration sensor may be disposed in a front direction and/or rear direction of the drum 40. Here, the front direction of the drum 40 may refer to a direction toward the front plate, and the rear direction of the drum 40 may refer to a direction toward the rear plate. The vibration sensor may detect vibration while the drum 40 rotates, and the controller 120 may calculate the eccentric value of the drum 40 based on the vibration value measured by the vibration sensor.

According to an embodiment, the washer 1 may measure the eccentric value in the front direction of the drum 40 and the eccentric value in the rear direction of the drum 40, respectively, using one vibration sensor. For example, the vibration sensor may be an inertial measurement unit (IMU) sensor (or an inertial measurement device). The IMU sensor may be configured to measure the acceleration corresponding to linear motion and the angular velocity corresponding to rotational motion for each of the x-axis, y-axis, and z-axis. The washer 1 may measure vibration values and/or eccentric values at a plurality of positions on the drum 40 using one IMU sensor. For example, in the washer 1, when the IMU sensor is disposed on the front side of the drum 40, the vibration value and/or the eccentric value in the rear of the drum 40 as well as in the front of the drum 40 may be measured/obtained. For example, when the IMU sensor is disposed on the rear side of the drum 40, the washer 1 may measure/obtain a vibration value and/or an eccentric value not only in the rear of the drum 40 but also in the front of the drum 40. For example, when the IMU is disposed at the central side of the drum 40, the washer 1 may measure vibration values and/or eccentric values, respectively, in the front and rear of the drum 40.

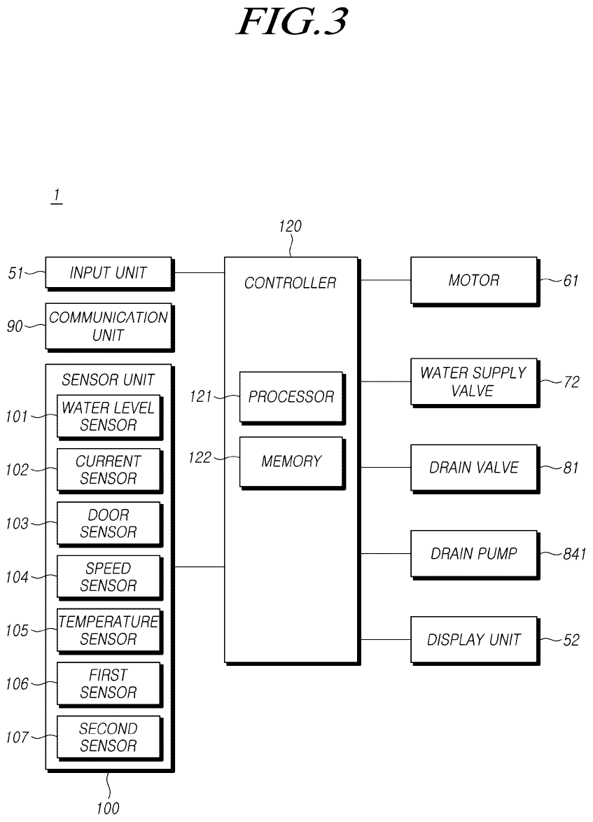

FIG. 3 is a functional block diagram schematically illustrating a configuration of a washer according to an embodiment of the disclosure in terms of functions and controls.

The washer 1 may include an input unit 51 as described above with reference to FIG. 1. As described above, the input unit 51 may include any type of user input means for obtaining setting information from the user for controlling the operation of the washer 1. Various user inputs obtained through the input unit 51 may be transferred to the controller 120 to be described below. In an example, various user inputs obtained through the input unit 51 may be transmitted to the outside through the communication unit 90 to be described below, but the disclosure is not limited thereto.

In an example, the washer 1 may include a communication unit 90 that supports signal transmission/reception to/from the outside. In an example, the communicator 90 may receive and/or transmit a wired/wireless signal to/from an external wired/wireless communication system, an external server, and/or other devices according to a predetermined wired/wireless communication protocol. In an example, the communication unit 90 may include one or more modules to connect the washer 1 to one or more networks. In an example, the communication unit 90 may include at least one of a mobile communication module, a wired/wireless Internet module, a short-range communication module, and/or a location information module.

In an example, the mobile communication module may transmit/receive wireless signals with at least one of an external base station, an external terminal, and an external server through the mobile communication network according to any communication protocol among various communication protocols for mobile communication. The wireless signals may include various types of data signals. In an example, the wireless signals may include voice call signals, video call signals, and text/multimedia message signals, but the disclosure is not limited thereto.

For example, the wired/wireless Internet module may support wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), or long term evolution-advanced (LTE-A), but is not limited thereto. In an example, the wired/wireless Internet module of the communication unit 90 may transmit/receive data according to at least one wired/wireless Internet technology among Internet technologies not listed above.

The short-range communication module may be intended for, e.g., short-range communication and may support short-range communication using at least one of Bluetooth, radio frequency identification (RFID), infrared data association (IrDA), ultra-wideband (UWB), ZigBee, near-field communication (NFC), Wi-Fi, Wi-Fi Direct, or wireless universal serial bus (USB) technology. The short-range communication module may support, e.g., wireless communication between the washer 1 and a wireless communication system, between the washer 1 and another device, or between the washer 1 and a network in which the other device is positioned through a short-range wireless communication network.

The location information module may be, e.g., a global positioning system (GPS) module or a Wi-Fi module as a module for obtaining the location of the washer 1. When the washer 1 utilizes the GPS module, the washer 1 may receive information about the location of the washer 1 using the signal transmitted from the GPS satellite. When the washer 1 utilizes the Wi-Fi module, the washer 1 may receive information about the location of the washer 1 based on information about a wireless access point (AP) that transmits and receives a wireless signal to and from the Wi-Fi module.

In an example, the communication unit 90 may receive the configuration data signal input by the user on the mobile terminal of the user in the form of a wireless signal according to a predetermined wireless communication protocol. In an example, the communication unit 90 may receive information and/or a command for controlling the operation of the washer 1 from an external server in the form of a signal according to a predetermined wired/wireless communication protocol. The communication unit 90 may transfer various received signals to the controller 120 to be described below. In an example, the communication unit 90 may transmit various data generated or obtained on the washer 1 in the form of a wired/wireless signal according to a predetermined wired/wireless communication protocol, e.g., to a mobile terminal of the user or an external server.

According to an embodiment, the washer 1 may include a sensor unit 100 for detecting an operating state and/or an internal environment of the washer 1. In an example, the sensor unit 100 may include a water level sensor 101, a current sensor 102, a door sensor 103, a speed sensor 104, a temperature sensor 105, a first sensor 106, and/or a second sensor 107, but this is illustrative and the disclosure is not limited thereto.

In an example, the water level sensor 101 is a sensor provided to detect the water level in the tub 30. In an example, the water level sensor 101 may be provided to identify a spinning progress or the like when performing the spinning process. The water level sensor 101 may transfer an electrical signal related to the water level in the tub 30 to the controller 120.

The current sensor 102 may be provided to detect the current flowing through the motor 61 of the driving device 60. The electrical signal related to the current value of the motor 61 generated by the current sensor 102 may be transferred to the controller 120.

The door sensor 103 may be provided to determine whether the door 20 is closed before the controller 120 performs the washing operation. An electrical signal regarding whether to open or close the door 20 generated by the door sensor 103 may be transferred to the controller 120.

The speed sensor 104 may be provided to detect the rotational speed, the rotational angle, or the rotational direction of the motor 61 or the drum 40. In an example, the speed sensor 104 may use, e.g., a scheme of detecting an on/off signal of the Hall sensor adjacent to the position of the rotor while the motor 61 is running. In an example, the speed sensor 104 may use a scheme of measuring the magnitude of the current applied to the motor 61 while the drum 40 rotates. An electrical signal regarding the rotational speed, the rotational angle, or the rotational direction of the drum 40 generated by the speed sensor 104 may be transferred to the controller 120.

The temperature sensor 105 may be provided to detect the ambient environment temperature of the washer 1 or the temperature of the internal components, or to detect the temperature of the washing water in the tub 30. The temperature sensor 105 may be implemented as, e.g., a thermistor, which is a type of resistor using the property that the resistance of a material changes according to the temperature. The electrical signal related to the temperature generated by the temperature sensor 105 may be transferred to the controller 120.

The first sensor 106 and the second sensor 107 may be sound sensors capable of detecting and measuring the sound (e.g., voice, sound, noise, or sound wave) generated in the ambient environment. The first sensor 106 and the second sensor 107 may convert the vibration of the sound into an electrical signal and process the same. The first sensor 106 and the second sensor 107 may include, but are not limited to, e.g., a microphone, a sound pressure sensor, a sound velocity sensor, and/or an acoustic sensor. In the disclosure, the first sensor 106 and the second sensor 107, respectively, may be referred to as a first sound sensor and a second sound sensor.

According to an embodiment, the washer 1 may include the controller 120 for controlling the overall operation of the washer 1. The controller 120 may include a memory 122 for storing or recording a program and/or data for controlling each component of the washer 1, and a processor 121 for generating a control signal for controlling each component of the washer 1 according to the program and/or data stored in the memory 122 and information obtained from each of the other components.

According to an example, the memory 122 may store various data that may be used to control the operation of each component of the washer 1. The memory 122 may store, e.g., a plurality of application programs used in the washer 1, data for controlling the operation of the washer 1, and instructions. At least some of the application programs stored in the memory 122 may be downloaded from an external server through wireless communication. At least some of the application programs stored in the memory 122 may be stored in the memory 122 from the time of shipment for the basic functions of the washer 1. In an example, the memory 122 may store various data serving as a reference that may be used to proceed with the spinning cycle to be described below.

In an example, the processor 121 of the controller 120 may receive various input/setting information, e.g., power on/off of the washer 1, washer operation setting information (e.g., operation start/stop, course selection, time selection, etc.), or other various control information from the input unit 51 and/or the communication unit 90 described above. The processor 121 may obtain various sensing information, e.g., information about the water level in the tub 30 sensed by the water level sensor 101, information about the current flowing through the motor 61 sensed by the current sensor 102, information indicating whether the door is opened or closed as sensed by the door sensor 103, information about the rotational speed of the motor 61 or the drum 40 sensed by the speed sensor 104, and the like, from the sensor unit 100. The processor 121 may obtain, e.g., information indicating the amount of vibration of the drum 40 from the vibration sensor to estimate or obtain the eccentric value of the drum 40. The processor 121 may estimate or obtain, e.g., a front eccentric value of the drum 40 and a rear eccentric value of the drum 40 using one vibration sensor.

In an example, the processor 121 of the controller 120 may generate an operation control command for each component of the washer 1, based on various information received from the input unit 51, the communication unit 90, and/or the sensor unit 100. In an example, the processor 121 may control each related component to perform at least one of the washing cycle, the rinsing cycle, the spinning cycle, or the drying cycle. The processor 121 may control the operation of, e.g., the driving device 60, the water supply device 70, and/or the drain device 80 to control the execution of at least one of the washing operation, the rinsing operation, the spinning operation, or the drying operation. In an example, the processor 121 may rotate the drum 40 by controlling the driving of the motor 61 of the driving device 60. For example, the processor 121 may control the opening and closing of the water supply valve 72 of the water supply device 70 to adjust the washing water supplied to the drum 40 and/or the tub 30. For example, the processor 121 may control the drain valve 81 and/or the drain pump 841 of the drain device 80 to drain the washing water in the drum 40 and/or the tub 30. In an example, the processor 121 may continuously obtain information from the input unit 51, the communication unit 90, and/or the sensor unit 100 while performing at least one of the washing cycle, the rinsing cycle, the spinning cycle, or the drying cycle, and may continuously update and control the operation of each component based on the obtained information.

In an example, the processor 121 of the controller 120 may generate a command for controlling whether and how to display information through the display unit 52, based on various types of information received from the input unit 51, the communication unit 90, and/or the sensor unit 100.

In these drawings, it is disclosed that the controller 120 is a comprehensive component for controlling all the components included in the washer 1, but the disclosure is not limited thereto. In an example, the washer 1 may be configured to include a plurality of controller components that individually control some of the components of the washer 1. In an example, the washer 1 may include a separate controller having a processor and memory for controlling the operation of the driving device 60, e.g., the motor 61. In an example, the washer 1 may include a separate controller having a processor and memory for controlling the operation of a user interface according to a user input. The processor 121 of the controller 120 may include a plurality of processors, and the memory 122 may include a plurality of memory devices.

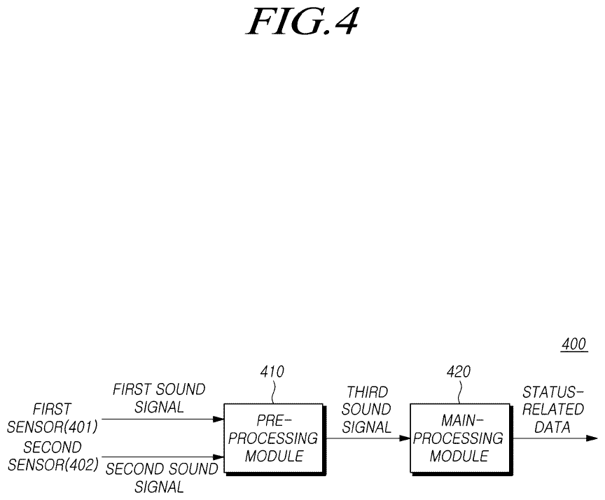

FIG. 4 is a view illustrating an example configuration of a home appliance according to an embodiment of the disclosure.

Referring to FIG. 4, the home appliance 400 (e.g., the washer 1 of FIG. 1) may include a first sensor 401 (e.g., the first sensor 106 of FIG. 3), a second sensor 402 (e.g., the second sensor 107 of FIG. 3), a pre-processing module 410, and/or a main-processing module 420. In the disclosure, the pre-processing module 410 may be referred to as a first processing module, and the main processing module 420 may be referred to as a second processing module.

According to an embodiment, the first sensor 401 and the second sensor 402 may be sound sensors capable of detecting and measuring sound (e.g., voice, sound, noise, and sound waves) generated in an ambient environment. The first sensor 401 and the second sensor 402 may convert the vibration of the sound into an electrical signal and process the same. The first sensor 401 and the second sensor 402 may include, but are not limited to, e.g., a microphone, a sound pressure sensor, a sound velocity sensor, and/or an acoustic sensor.

According to an embodiment, in the home appliance 400, the first sensor 401 may be configured so that an operation sound generated inside (or in the internal space) the home appliance 400 reaches the first sensor 401 before the second sensor 402. For example, in the home appliance 400, the first sensor 401 may be disposed so that an operation sound generated inside (or in the internal space) the home appliance 400 reaches the first sensor 401 before the second sensor 402.

According to an embodiment, the second sensor 402 in the home appliance 400 may be configured so that an external sound generated outside (or in an external space) the home appliance 400 reaches the second sensor 402 before the first sensor 401. For example, in the home appliance 400, the second sensor 402 may be disposed so that an external sound generated outside (or in an external space) of the home appliance 400 reaches the second sensor 402 before the first sensor 401.

According to an embodiment, the operation sound may be a sound generated inside the home appliance according to the operation of the home appliance. The home appliance may generate different operation sounds depending on, e.g., the type of the home appliance, the status of the home appliance, and the operation mode.

According to an embodiment, the external sound is a sound generated outside the home appliance, and may be, e.g., a sound such as the user's conversation, an external noise, or an operation sound of the external home appliance. When diagnosing the status of the home appliance using the sound detected (or measured) by the home appliance, such an external sound may act as noise and interfere with accurate state diagnosis.

According to an embodiment, the pre-processing module 410 and the main-processing module 420 may be implemented by at least one processor including a processing circuit. The at least one processor may implement the pre-processing module 410 and the main-processing module 420 by executing instructions that enable the home appliance 400 to individually and/or collectively perform various functions and/or operations of the pre-processing module 410 and the main-processing module 420.

According to an embodiment, the pre-processing module 410 may be implemented by at least one first processor including a processing circuit, and the main-processing module 420 may be implemented by at least one second processor including a processing circuit. As such, the pre-processing module 410 and the main-processing module 420 may be separated circuit-wise or physically. The at least one first processor may implement the pre-processing module 410 by executing instructions that enable the pre-processing module 410 to perform various functions and/or operations individually and/or collectively. The at least one second processor may implement the main-processing module 420 by executing instructions that enable the main-processing module 420 to perform various functions and/or operations individually and/or collectively. In the disclosure, the first processor may be referred to as a pre-processing processor, and the second processor may be referred to as a main-processing processor.

According to an embodiment, the pre-processing operation of the pre-processing module 410 may include at least one operation for generating a third sound signal using the first sound signal and the second sound signal.

According to an embodiment, the pre-processing module 410 may obtain the first sound signal using the first sensor 401.

According to an embodiment, the first sound signal may include a signal corresponding to an operation sound generated inside the home appliance 400 and/or a signal corresponding to an external sound generated outside the home appliance 400. In the disclosure, the signal corresponding to the operation sound may be referred to as an operation sound signal, and the signal corresponding to the external sound may be referred to as an external sound signal.

According to an embodiment, the pre-processing module 410 may obtain the second sound signal using the second sensor 402.

According to an embodiment, the second sound signal may include a signal corresponding to an operation sound generated inside the home appliance 400 and/or a signal corresponding to an external sound generated outside the home appliance 400.

According to an embodiment, the second sound signal may have a correlation with the signal corresponding to the external sound of the home appliance 400 included in the first sound signal. For example, the second sound signal may include the signal having the correlation with the signal corresponding to the external sound generated outside the home appliance 400. For example, external sounds generated from the same sound source in the external space of the home appliance 400 may reach the first sensor 401 and the second sensor 402, respectively, and signals corresponding to the corresponding external sounds detected by the first sensor 401 and the second sensor 402, respectively, may have a correlation with each other.

According to an embodiment, the pre-processing module 410 may generate a third sound signal by performing pre-processing on the first sound signal and the second sound signal using an adaptive filter.

According to an embodiment, the adaptive filter may simulate a relative delay time at which an external sound reaches each of the first sensor and the second sensor. The adaptive filter may be used to generate a partial signal having a correlation with the first sound signal detected by the first sensor using the second sound signal detected by the second sensor. For example, the adaptive filter may generate a partial signal having a correlation with the first sound signal by delaying the signal (second external sound signal) corresponding to the external sound included in the second sound signal detected by the second sensor to correspond to the signal (first external sound signal) corresponding to the external sound included in the first sound signal detected by the first sensor having a correlation with the second external sound signal. The generated partial signal may be used to remove or reduce the signal corresponding to the external sound included in the first sound signal.

According to an embodiment, the adaptive filter may be, e.g., a finite impulse response (FIR) filter, but is not limited thereto. For example, an infinite impulse response (IIR) filter may be used as the adaptive filter. When an FIR filter is used as the adaptive filter, stability may be higher than when an IIR filter is used as the adaptive filter. In the disclosure, the adaptive filter may be referred to as a weighted filter. In the disclosure, the third sound signal may be referred to as a pre-processed sound signal.

For example, the pre-processing module 410 may generate the filtered sound signal by filtering the second sound signal (or the signal generated based on the second sound signal) using the adaptive filter having a filter coefficient W, and may generate a third sound signal based on the first sound signal (or the signal generated based on the first sound signal) and the filtered sound signal.

According to an embodiment, the pre-processing module 410 may pre-filter at least one of the first sound signal or the second sound signal using a pre-filter. For example, the pre-processing module 410 may generate a pre-filtered first sound signal by pre-filtering the first sound signal using a first pre-filter, generate a pre-filtered second sound signal by pre-filtering the second sound signal using a pre-filter, generate a filtered second sound signal by filtering the pre-filtered second sound signal using the adaptive filter, and generate a third sound signal using the pre-filtered first sound signal and the filtered second sound signal. For example, the pre-processing module 410 may generate a pre-filtered first sound signal by pre-filtering the first sound signal using a pre-filter, generate a fourth sound signal using the pre-filtered first sound signal and the second sound signal, generate a filtered fourth sound signal by filtering the fourth sound signal using the adaptive filter, and generate a third sound signal using the first sound signal and the filtered fourth sound signal. For example, the pre-processing module 410 may filter the second sound signal using the adaptive filter to generate a filtered second sound signal, and may generate a third sound signal using the first sound signal and the filtered second sound signal.

The generated third sound signal may be a sound signal in which the signal corresponding to the external sound of the home appliance 400 is filtered (e.g., removed or reduced). For example, the third sound signal may be a sound signal in which the signal corresponding to the external sound included in the first sound signal is removed or reduced based on the second sound signal.

According to an embodiment, the pre-filter may be used to set a first frequency band of interest. The pre-filter may be a low pass filter, a high pass filter, or a band pass filter, but is not limited thereto. For example, various types of filters for giving a weight for each frequency may be used as pre-filters. When pre-filtering is performed, filtering performance in the pre-processing process of the pre-processing module 410 may be enhanced as compared to when pre-filtering is not performed.

According to an embodiment, the filter coefficient of the adaptive filter may be updated using a preconfigured adaptive algorithm based on the third sound signal and the second sound signal. The adaptive algorithm may be, e.g., a least mean squared (LMS) algorithm, but is not limited thereto. The filter coefficient W of the adaptive filter may be updated to minimize, e.g., a correlation between the second sound signal and the third sound signal.

According to an embodiment, the update period for the filter coefficient of the adaptive filter may be associated with the sampling period for the adaptive filter. For example, the update period for the filter coefficient may be the same as the sampling period. When the update period for the filter coefficient matches the sampling period, the filter coefficient may be updated for each sample (or each time step). The updated filter coefficient may be used for pre-processing the first sound signal and the second sound signal of the next time step.

Through the pre-processing operation of the pre-processing module 410 including the operation of updating the filter coefficient of the adaptive filter, the signal corresponding to the external sound of the home appliance 400 included in the first sound signal may be removed based on the second sound signal, so that the third sound signal including only the signal corresponding to the operation sound of the home appliance 400 may be obtained.

According to an embodiment, the pre-processing module 410 may transfer data of the third sound signal to the main-processing module 420. As described above, since the pre-processing module 410 and the main-processing module 420 may be separated circuit-wise or physically, and the third sound signal corresponds to the signal obtained by filtering the signal corresponding to the external sound associated with the user's privacy, the user's privacy may be guaranteed when the first sound signal and the second sound signal including the signal corresponding to the external sound are not transferred to the main-processing module 420 but only the pre-processed third sound signal is transferred to the main-processing module 420.

According to an embodiment, the main-processing module 420 may obtain data related to the status of the home appliance 400 (hereinafter, referred to as status-related data), based on the data of the third sound signal. For example, the main-processing module 420 may generate the status-related data using the data of the third sound signal.

According to an embodiment, the status-related data may include feature data for diagnosing the status of the home appliance 400 and/or diagnosis result data obtained based on the feature data. The feature data may include, e.g., at least one feature value used to diagnose the status of the home appliance 400. The diagnosis result data may include, e.g., first result data including a result of diagnosing the status of the home appliance 400 based on the feature data and/or second result data including a result of comprehensively determining the status of the home appliance 400 based on the first result data.

According to an embodiment, the main-processing module 420 may obtain at least one piece of feature data, based on the data of the third sound signal. For example, the main-processing module 420 may generate feature data of each corresponding time step using the value of the third sound signal of each time step. In other words, the main-processing module 420 may generate feature data for each time step.

According to an embodiment, the main-processing module 420 may obtain at least one piece of first result data based on the at least one piece of feature data. The first result data may include, e.g., first information indicating whether the status of the home appliance is normal or abnormal (e.g., failure) and/or second information indicating the cause or type of abnormality (e.g., cause of failure) when the status of the home appliance is abnormal.

According to an embodiment, the main processing module 420 may perform an inference operation using a trained artificial intelligence (AI) model to obtain the first result data. For example, the main-processing module 420 may input at least one piece of feature data to the AI model as input data, and obtain the at least one piece of first result data as output data of the AI model. The main-processing module 420 may generate one first result data for each feature data, or may generate one first result data for a plurality of feature data.

According to an embodiment, the main-processing module 420 may obtain second result data, based on at least one first result data. For example, the main-processing module 420 may generate the second result data including the result of comprehensively determining the status of the home appliance 400 by analyzing the history of diagnosing the status of the home appliance 400 using the at least one first result data.

According to an embodiment, the home appliance 400 may transmit the status-related data to an external electronic device (e.g., a server) through a communication module (e.g., a transceiver). The external electronic device to which the status-related data is transmitted may be, e.g., a server to which the home appliance 400 is registered. The status-related data may include feature data and/or diagnosis result data.

According to an embodiment, the communication module may be connected only to the main-processing module 420 but may not be connected to the pre-processing module 410. Accordingly, the signal corresponding to the external sound associated with the user's privacy may not be exposed to the outside of the home appliance 400.

According to an embodiment, when the status-related data transmitted to the external electronic device includes feature data, the external electronic device may obtain (or generate) diagnosis result data based on the feature data. In this case, the main-processing module 420 may transmit the feature data itself to the external electronic device without performing the operation of obtaining the diagnosis result data based on the above-described feature data, and the external electronic device may obtain the diagnosis result data based on the received feature data. The external electronic device may update the status information about the home appliance 400 based on the diagnosis result data.

According to an embodiment, when the status-related data transmitted to the external electronic device includes the diagnosis result data, the external electronic device may update the status information about the home appliance 400 based on the diagnosis result data.

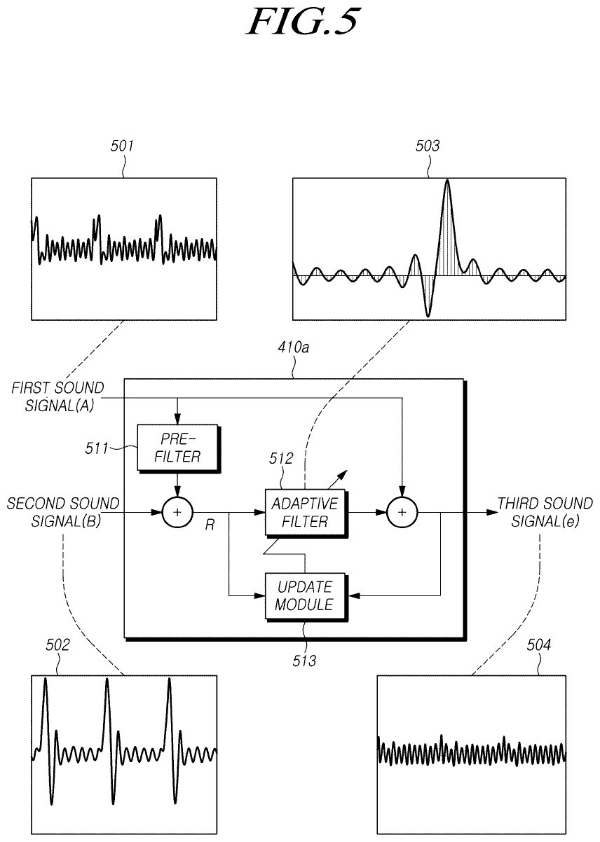

FIG. 5 illustrates an example configuration of a pre-processing module according to an embodiment of the disclosure.

The pre-processing module 410a of the embodiment of FIG. 5 may be an example of the pre-processing module 410 of FIG. 4.

Referring to FIG. 5, the pre-processing module 410a may include a pre-filter 511, an adaptive filter 512, and an update module 513.

According to an embodiment, the pre-processing module 410a may obtain a first sound signal A and a second sound signal B. For example, the pre-processing module 410a may obtain the first sound signal A using a first sensor (e.g., the first sensor 401 of FIG. 4) and may obtain the second sound signal B using a second sensor (e.g., the second sensor 402 of FIG. 4). The waveform of the first sound signal A may be, e.g., the same as the waveform 501, and the waveform of the second sound signal B may be, e.g., the same as the waveform 502.

The first sound signal A may be expressed, e.g., by Equation 1 below.

$$A = {H}_{2 A} D + {H}_{1 A} N + {V}_{A} \qquad [ Equation 1 ]$$

Here, D is the external sound signal generated from the sound source corresponding to the external sound, N is the operation sound signal generated from the sound source corresponding to the operation sound, H_{2A} is the transfer function for the external sound signal and the first sensor (e.g., a transfer signal using the external sound signal D generated from the corresponding sound source as an input and the external sound signal measured by the first sensor as an output), H_{1A} is the transfer function for the operation sound signal and the first sensor (e.g., a transfer function using the operation sound signal N generated from the corresponding sound source as an input and the operation sound signal measured by the first sensor as an output).

The second sound signal B may be expressed, e.g., by Equation 2 below.

$$B = {H}_{1 B} D + {H}_{2 B} N + {V}_{B} \qquad [ Equation 2 ]$$

Here, D is the external sound signal generated from the sound source corresponding to the external sound, N is the operation sound signal generated from the sound source corresponding to the operation sound, H_{1B} is the transfer function for the external sound signal and the second sensor (e.g., a transfer signal using the external sound signal D generated from the corresponding sound source as an input and the external sound signal measured by the second sensor as an output), H_{2B} is the transfer function for the operation sound signal and the second sensor (e.g., a transfer function using the operation sound signal N generated from the corresponding sound source as an input and the operation sound signal measured by the second sensor as an output).

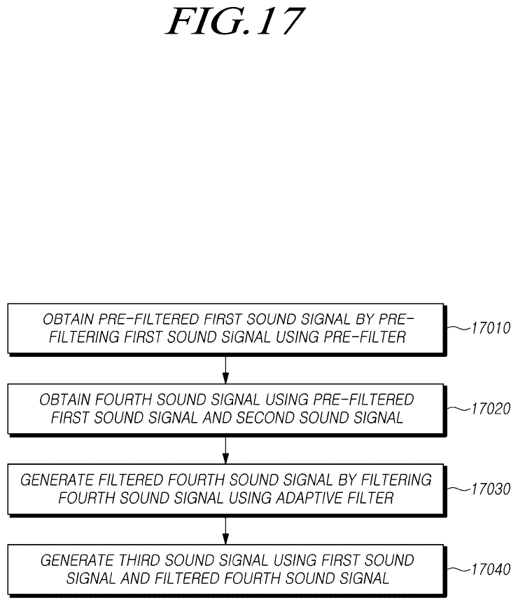

According to an embodiment, the pre-processing module 410a may obtain a pre-filtered first sound signal A′ by pre-filtering the first sound signal A using the pre-filter 511 (e.g., operation 17010 of FIG. 17). The pre-filter 511 may be used to set a first frequency band of interest. The pre-filter may be a low pass filter, a high pass filter, or a band pass filter, but is not limited thereto. For example, various types of filters for giving a weight for each frequency may be used as the pre-filter 511. When pre-filtering is performed, filtering performance in the pre-processing process may be enhanced as compared to when pre-filtering is not performed.

According to an embodiment, the pre-processing module 410a may obtain the fourth sound signal R using the pre-filtered first sound signal A′ and the second sound signal B (e.g., operation 17020 of FIG. 17). For example, the pre-processing module 410a may obtain the fourth sound signal R by synthesizing the pre-filtered first sound signal A′ and the second sound signal B using Equation 3 below.

$$R = B - \frac{{H}_{2 B}}{{H}_{1 A}} A \qquad [ Equation 3 ]$$

Here, R is the fourth sound signal, A is the first sound signal, B is the second sound signal, and H_{2B}/H_{1A} is the filter coefficient (or transfer function) of the pre-filter 511.

According to an embodiment, the filter coefficient of the pre-filter 511 may be determined based on the sound signal measured by the first sensor and the second sensor under the condition that only the operation sound is present without an external sound. Referring to Equation 3, the pre-filter 511 may output an impulse response A′ corresponding to the transfer function H_{2B}/H_{1A} for the first sound signal A.

According to an embodiment, the fourth sound signal R may be transferred to the adaptive filter 512. Further, the fourth sound signal R may be transferred to the update module 513 to update the filter coefficient W of the adaptive filter 512. According to an embodiment, the update module 513 may update the filter coefficient W of the adaptive filter 512 to minimize a correlation between the second sound signal and the third sound signal.

According to an embodiment, the pre-processing module 410a may generate a filtered fourth sound signal W*R by filtering the fourth sound signal R using the adaptive filter 512 (e.g., operation 17030 of FIG. 17). The waveform of the so-obtained filtered fourth sound signal may be the same as the waveform 503. The adaptive filter may be, e.g., an FIR filter.

According to an embodiment, the pre-processing module 410a may generate a third sound signal e using the first sound signal A and the filtered fourth sound signal W*R (e.g., operation 17040 of FIG. 17). For example, the pre-processing module 410a may generate the third sound signal e by synthesizing the first sound signal A and the filtered fourth sound signal W*R using Equation 4 below.

$$e = A - W ⋆ R \qquad [ Equation 4 ]$$

According to an embodiment, the filter coefficient W of the adaptive filter 512 may be updated by the update module 513 using the configured adaptive algorithm based on the third sound signal e and the fourth sound signal R. Therefore, as can be seen from FIG. 5, the third sound signal e and the second sound signal B may be used to update the filter coefficient W of the adaptive filter 512 via an adaptive algorithm. The adaptive algorithm may be, e.g., an LMS algorithm, but is not limited thereto.

According to an embodiment, the update period for the filter coefficient W of the adaptive filter 512 may be associated with the sampling period for the adaptive filter. For example, the update period for the filter coefficient may be the same as the sampling period (e.g., the size of the time step (hereinafter, the sampling period associated with the step size)). When the update period for the filter coefficient matches the sampling period, the filter coefficient may be updated for each sample (or each time step).

According to an embodiment, the filter coefficient W of the adaptive filter 512 may be updated by Equation 5 below.

$$W ← W - μ ze \qquad [ Equation 5 ]$$

Here, W may be the filter coefficient, may be the step size of the adaptive filter 512, z may be the fourth sound signal R, and e may be the third sound signal.

According to an embodiment, the filter coefficient W of the adaptive filter 512 may converge to, e.g., a value of a transfer function as shown in Equation 6 below through an update operation of the update module 513.

$$W \to \frac{{H}_{1 A} {H}_{2 A}}{{H}_{1 B} {H}_{1 A} - {H}_{2 B} {H}_{2 A}} \qquad [ Equation 6 ]$$

Referring to Equation 6, the output of the adaptive filter 512 for the fourth sound signal R may converge to an impulse response corresponding to the transfer function

$$\frac{{H}_{1 A} {H}_{2 A}}{{H}_{1 B} {H}_{1 A} - {H}_{2 B} {H}_{2 A}} .$$

The pre-processing operation of the pre-processing module 410a including the operation of updating the filter coefficient W of the adaptive filter 512 using Equation 5 may be described as follows.

In the first time step T1, the pre-processing module 410a may perform the pre-processing operation using the filter coefficient W1 (e.g., a set initial filter coefficient). For example, in the first time step, the pre-processing module 410a may obtain the first sound signal A1 and the second sound signal B1, obtain the pre-filtered first sound signal A1′ by pre-filtering the first sound signal A1, obtain the fourth sound signal z1=R1 by synthesizing the pre-filtered first sound signal A1′ and the second sound signal B1, obtain the filtered fourth sound signal W1*R1 by filtering the fourth sound signal R1 using the adaptive filter having the filter coefficient W1, and obtain the third sound signal (e1=A1−W1*R1) using the first sound signal A1 and the filtered fourth sound signal W1*R1.

Thereafter, the pre-processing module 410a may update the filter coefficient W1 using Equation 6 to obtain the filter coefficient W2 to be used for the pre-processing operation in the second time step. The so-obtained filter coefficient W2 may be W2=W1−z1e1.

In the second time step T2, the pre-processing module 410a may perform the pre-processing operation using the updated filter coefficient W2. For example, in the second time step, the pre-processing module 410a may obtain the first sound signal A2 and the second sound signal B2, obtain the pre-filtered first sound signal A2′ by pre-filtering the first sound signal A2, obtain the fourth sound signal z2=R2 by synthesizing the pre-filtered first sound signal A2′ and the second sound signal B2, obtain the filtered fourth sound signal W2*R2 by filtering the fourth sound signal R2 using the adaptive filter having the filter coefficient W2, and obtain the third sound signal (e2=A2-W2*R2) using the first sound signal A2 and the filtered fourth sound signal W2*R2.

Thereafter, the pre-processing module 410a may update the filter coefficient W2 using Equation 6 to obtain the filter coefficient W3 to be used for the pre-processing operation in the third time step. The so-obtained filter coefficient W3 may be W3=W2−z2e2.

Thereafter, the pre-processing module 410a may perform the pre-processing operation using the filter coefficient updated in each subsequent time step corresponding to the number of time steps, and obtain the third sound signal of the corresponding time step. For example, when the number of time steps is 5, the pre-processing module 410a may perform the pre-processing operation using the filter coefficient updated in each of the subsequent third time step, fourth time step, and fifth time step to obtain each third sound signal of the third time step, the fourth time step, and the fifth time step.

The waveform of the so-obtained third sound signal e may be the same as, e.g., the waveform 504. As illustrated, the waveform 504 may have a form in which the portion corresponding to the external sound of the home appliance is removed (or reduced) from the waveform 501 of the first sound signal A to include only the portion corresponding to the operation sound of the home appliance. Through the pre-processing operation including the operation of updating the filter coefficient of the adaptive filter, the third sound signal obtained by filtering (e.g., removing) the signal corresponding to the external sound of the home appliance included in the first sound signal may be obtained.

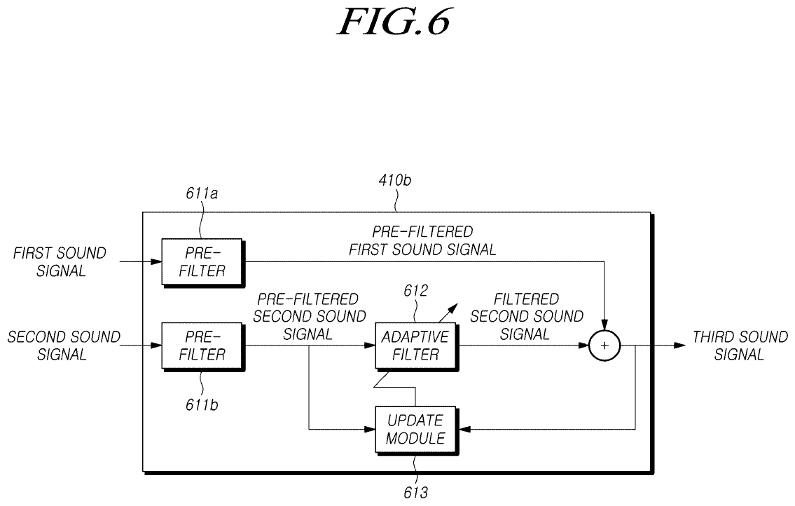

FIG. 6 illustrates an example configuration of a pre-processing module according to an embodiment of the disclosure.

The pre-processing module 410b of the embodiment of FIG. 6 may be an example of the pre-processing module 410 of FIG. 4.

Referring to FIG. 6, the pre-processing module 410b may include a first pre-filter 611a, a second pre-filter 611b, an adaptive filter 612, and an update module 613.

According to an embodiment, the pre-processing module 410b may obtain a first sound signal A and a second sound signal B. For example, the pre-processing module 410b may obtain the first sound signal A using a first sensor (e.g., the first sensor 401 of FIG. 4) and may obtain the second sound signal B using a second sensor (e.g., the second sensor 402 of FIG. 4).

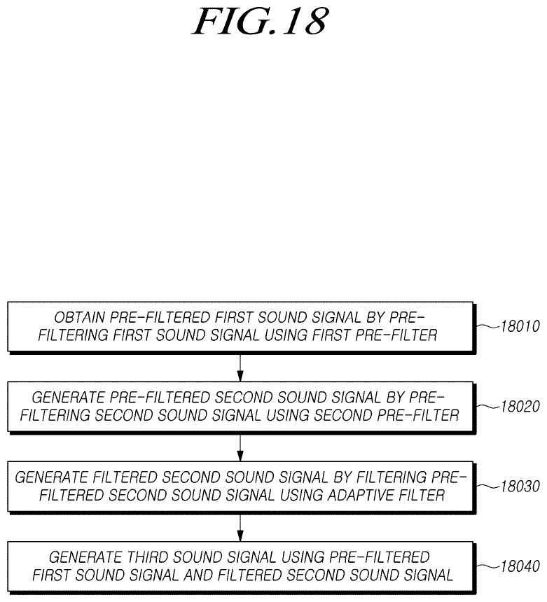

According to an embodiment, the pre-processing module 410b may obtain a pre-filtered first sound signal A′ by pre-filtering the first sound signal A using the first pre-filter 611a (e.g., operation 18010 of FIG. 18). The first pre-filter 611a may be used to set a first frequency band of interest. The first pre-filter 611a may be a low pass filter, a high pass filter, or a band pass filter, but is not limited thereto. For example, various types of filters for giving a weight for each frequency may be used as the first pre-filter 611a. When pre-filtering is performed, filtering performance in the pre-processing process may be enhanced as compared to when pre-filtering is not performed.

According to an embodiment, the pre-processing module 410b may obtain a pre-filtered second sound signal B′ by pre-filtering the second sound signal B using the second pre-filter 611b (e.g., operation 18020 of FIG. 18). The second pre-filter 611b may be used to set a second frequency band of interest. The second pre-filter 611b may be a low pass filter, a high pass filter, or a band pass filter, but is not limited thereto. For example, various types of filters for giving a weight for each frequency may be used as the second pre-filter 611b.

According to an embodiment, the first frequency band of interest of the first pre-filter 611a may differ from the second frequency band of interest of the second pre-filter 611b. For example, the first frequency band of interest of the first pre-filter 611a may be higher than the second frequency band of interest of the second pre-filter 611b.

According to an embodiment, the pre-filtered second sound signal B′ may be transferred to the adaptive filter 612. Further, the pre-filtered second sound signal B′ may be transferred to the update module 613 using an adaptive algorithm to update the filter coefficient W of the adaptive filter 612. According to an embodiment, the update module 613 may update the filter coefficient W of the adaptive filter 512 to minimize a correlation between the second sound signal and the third sound signal.

According to an embodiment, the pre-processing module 410b may generate a filtered second sound signal W*B′ by filtering the pre-filtered second sound signal B′ using the adaptive filter 612 (e.g., operation 18030 of FIG. 18). The adaptive filter may be, e.g., an FIR filter.

According to an embodiment, the pre-processing module 410b may generate a third sound signal e using the pre-filtered first sound signal A′ and the filtered second sound signal W*B′ (e.g., operation 18040 of FIG. 18). For example, the pre-processing module 410b may generate the third sound signal e by synthesizing the pre-filtered first sound signal A′ and the filtered second sound signal W*B using Equation 7 below.

$$e = {A}^{′} - W ⋆ {B}^{′} \qquad [ Equation 7 ]$$

According to an embodiment, the filter coefficient W of the adaptive filter 612 may be updated by the update module 613 using the preconfigured adaptive algorithm based on the third sound signal e and the pre-filtered second sound signal B′. Therefore, as can be seen from FIG. 6, the third sound signal e and the second sound signal B may be used to update the filter coefficient W of the adaptive filter 612 via an adaptive algorithm. The adaptive algorithm may be, e.g., an LMS algorithm, but is not limited thereto.

According to an embodiment, the update period for the filter coefficient of the adaptive filter 612 may be associated with the sampling period for the adaptive filter. For example, the update period for the filter coefficient may be the same as the sampling period (e.g., the sampling period associated with the step size). When the update period for the filter coefficient matches the sampling period, the filter coefficient may be updated for each sample (or each time step).

According to an embodiment, the filter coefficient of the adaptive filter 612 may be updated by Equation 8 below.

$$W ← W - μ xe \qquad [ Equation 8 ]$$

Here, W may be the filter coefficient, may be the step size of the adaptive filter, x may be the pre-filtered second sound signal (x=B′), and e may be the third sound signal.

The pre-processing operation of the pre-processing module 410b including the operation of updating the filter coefficient of the adaptive filter 612 using Equation 8 may be described as follows.

In the first time step T1, the pre-processing module 410b may perform the pre-processing operation using the filter coefficient W1 (e.g., a set initial filter coefficient). For example, in the first time step, the pre-processing module 410b may obtain the first sound signal A1 and the second sound signal B1, obtain the pre-filtered first sound signal A1′ and the pre-filtered second sound signal (x1=B1′) by pre-filtering the first sound signal A1 and the second sound signal B1, respectively, obtain the filtered second sound signal W1*B1′ by filtering the pre-filtered second sound signal B1′ using the adaptive filter having the filter coefficient W1, and obtain the third sound signal (e1=A1′−W1*B1′) using the pre-filtered first sound signal A1′ and the filtered second sound signal W1*B1′.

Thereafter, the pre-processing module 410b may update the filter coefficient W1 using Equation 8 to obtain the filter coefficient W2 to be used for the pre-processing operation in the second time step. The so-obtained filter coefficient W2 may be W2=W1−μx1e1.

In the second time step T2, the pre-processing module 410b may perform the pre-processing operation using the updated filter coefficient W2. For example, in the second time step, the pre-processing module 410b may obtain the first sound signal A2 and the second sound signal B2, obtain the pre-filtered first sound signal A2′ and the pre-filtered second sound signal (x2=B2′) by pre-filtering the first sound signal A2 and the second sound signal B2, respectively, obtain the filtered second sound signal W2*B2′ by filtering the pre-filtered second sound signal B2′ using the adaptive filter having the filter coefficient W2, and obtain the third sound signal (e2=A2′−W2*B2′) using the pre-filtered first sound signal A2′ and the filtered second sound signal W2*B2′.

Thereafter, the pre-processing module 410b may update the filter coefficient W2 using Equation 8 to obtain the filter coefficient W3 to be used for the pre-processing operation in the third time step. The so-obtained filter coefficient W3 may be W3=W2−x2e2.

Thereafter, the pre-processing module 410b may perform the pre-processing operation using the filter coefficient updated in each subsequent time step corresponding to the number of time steps, and obtain the third sound signal of the corresponding time step. For example, when the number of time steps is 5, the pre-processing module 410b may perform the pre-processing operation using the filter coefficient updated in each of the subsequent third time step, fourth time step, and fifth time step to obtain each third sound signal of the third time step, the fourth time step, and the fifth time step.

Through the pre-processing operation including the operation of updating the filter coefficient of the adaptive filter, the third sound signal obtained by filtering (e.g., removing or reducing) the signal corresponding to the external sound of the home appliance included in the first sound signal may be obtained.

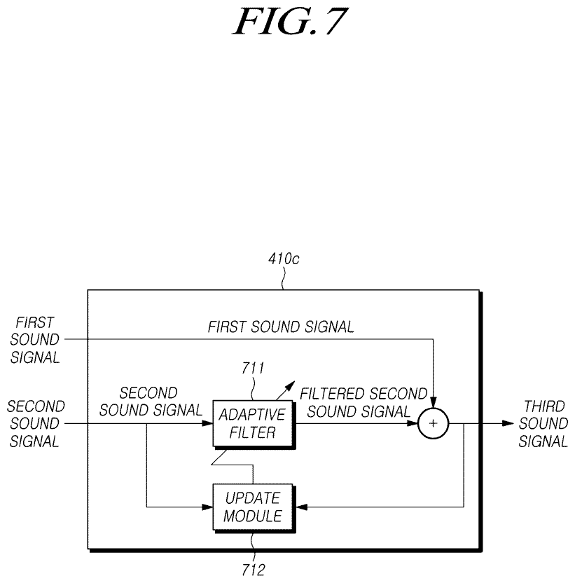

FIG. 7 illustrates an example configuration of a pre-processing module according to an embodiment of the disclosure.

The pre-processing module 410c of the embodiment of FIG. 7 may be an example of the pre-processing module 410 of FIG. 4.

Referring to FIG. 7, the pre-processing module 410c may include an adaptive filter 711 and an update module 712. Unlike the embodiment of FIG. 6, the pre-processing module 410c of the embodiment of FIG. 7 does not include a pre-filter.

According to an embodiment, the pre-processing module 410c may obtain a first sound signal A and a second sound signal B. For example, the pre-processing module 410c may obtain the first sound signal A using a first sensor (e.g., the first sensor 401 of FIG. 4) and may obtain the second sound signal B using a second sensor (e.g., the second sensor 402 of FIG. 4). The second sound signal B may be transferred to an adaptive filter 711 and an update module 712. According to an embodiment, the update module 513 may update the filter coefficient W of the adaptive filter 512 to minimize a correlation between the second sound signal and the third sound signal.

According to an embodiment, the pre-processing module 410c may generate a filtered second sound signal W*B′ by filtering the second sound signal B using the adaptive filter 712. The adaptive filter may be, e.g., an FIR filter.

According to an embodiment, the pre-processing module 410c may generate a third sound signal e using the first sound signal A and the filtered second sound signal W*B. For example, the pre-processing module may generate the third sound signal e by synthesizing the first sound signal A and the filtered second sound signal W*B using Equation 9 below.

$$e = A - W ⋆ B \qquad [ Equation 9 ]$$

According to an embodiment, the filter coefficient W of the adaptive filter 712 may be updated by the update module 713 using the preconfigured adaptive algorithm based on the third sound signal e and the second sound signal B. Therefore, as can be seen from FIG. 7, the third sound signal e and the second sound signal B may be used to update the filter coefficient W of the adaptive filter 712 via an adaptive algorithm. The adaptive algorithm may be, e.g., an LMS algorithm, but is not limited thereto.

According to an embodiment, the update period for the filter coefficient of the adaptive filter 712 may be associated with the sampling period for the adaptive filter. For example, the update period for the filter coefficient may be the same as the sampling period (e.g., the sampling period associated with the step size). When the update period for the filter coefficient matches the sampling period, the filter coefficient may be updated for each sample (or each time step).

According to an embodiment, the filter coefficient of the adaptive filter 712 may be updated by Equation 10 below.

$$W ← W - μ ye \qquad [ Equation 10 ]$$

Here, W may be the filter coefficient, may be the step size of the adaptive filter, y may be the second sound signal (x=B), and e may be the third sound signal.

The pre-processing operation of the pre-processing module 410c including the operation of updating the filter coefficient of the adaptive filter 712 using Equation 10 may be described as follows.

In the first time step T1, the pre-processing module 410c may perform the pre-processing operation using the filter coefficient W1. For example, in the first time step, the pre-processing module 410c may obtain the first sound signal A1 and the second sound signal (y1=B1), obtain the filtered second sound signal W1*B1 by filtering the second sound signal B1 using the adaptive filter having the filter coefficient W1, and obtain the third sound signal (e1=A1−W1*B1) using the first sound signal A1 and the filtered second sound signal W1*B1.

Thereafter, the pre-processing module 410c may update the filter coefficient W1 using Equation 10 to obtain the filter coefficient W2 to be used for the pre-processing operation in the second time step. The so-obtained filter coefficient W2 may be W2=W1−μy1e1.

In the second time step T2, the pre-processing module 410c may perform the pre-processing operation using the updated filter coefficient W2. For example, in the second time step, the pre-processing module 410c may obtain the first sound signal A2 and the second sound signal (y2=B2), obtain the filtered second sound signal W2*B2 by filtering the second sound signal B2 using the adaptive filter having the filter coefficient W2, and obtain the third sound signal (e2=A2−W2*B2) using the first sound signal A2 and the filtered second sound signal W2*B2.

Thereafter, the pre-processing module 410c may update the filter coefficient W2 using Equation 10 to obtain the filter coefficient W3 to be used for the pre-processing operation in the third time step. The so-obtained filter coefficient W3 may be W3=W2−μy2e2.

Thereafter, the pre-processing module 410c may perform the pre-processing operation using the filter coefficient updated in each subsequent time step corresponding to the number of time steps, and obtain the third sound signal of the corresponding time step. For example, when the number of time steps is 5, the pre-processing module 410c may perform the pre-processing operation using the filter coefficient updated in each of the subsequent third time step, fourth time step, and fifth time step to obtain each third sound signal of the third time step, the fourth time step, and the fifth time step.

Through the pre-processing operation including the operation of updating the filter coefficient of the adaptive filter, the third sound signal obtained by filtering (e.g., removing or reducing) the signal corresponding to the external sound of the home appliance included in the first sound signal may be obtained.

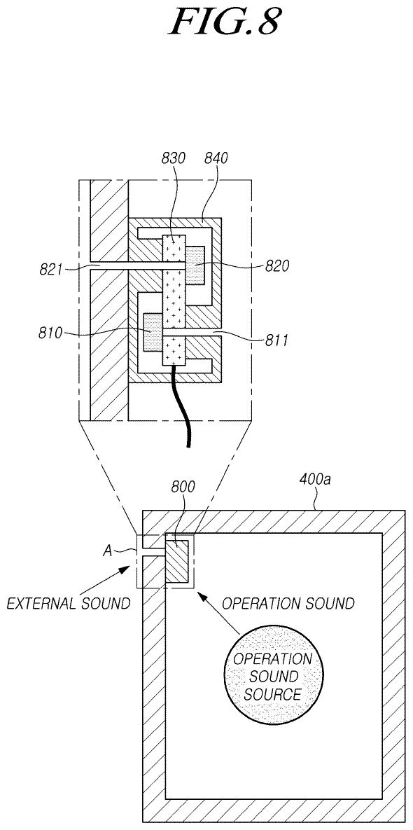

FIG. 8 illustrates a sensor assembly and an arrangement structure of the sensor assembly according to an embodiment of the disclosure.

Referring to FIG. 8, a home appliance 400a (e.g., the home appliance 400) may be a home appliance having a closed internal space. For example, the home appliance 400a may be a washer having a closed internal space.

According to an embodiment, a sensor assembly 800 may be disposed inside (e.g., inside an upper end) the home appliance 400a. For example, the sensor assembly 800 may be mounted on a portion of the inner surface of the housing of the home appliance 400a.

According to an embodiment, the sensor assembly 800 may include at least two sensors. In the disclosure, the sensor assembly may be referred to as a sensor module.

Referring to the enlarged portion of area A, the sensor assembly 800 may include at least one first sensor 810 (e.g., the first sensor 401 of FIG. 4), at least one second sensor 820 (e.g., the second sensor 402 of FIG. 4), and a printed circuit board 830 on which the first sensor 810 and the second sensor 820 are disposed.

According to an embodiment, the first sensor 810 may be disposed so that an operation sound signal generated inside (or in the internal space) the home appliance reaches the first sensor 810 before the second sensor 820. For example, the first sensor 810 may be disposed adjacent to a first passage 811 that is open toward the inside of the home appliance 400a. For example, the first sensor 810 may be disposed adjacent to the other end of the first passage 811 having one end open toward the inside of the home appliance 400a. In this case, the one end of the first passage 811 may be open toward the inside of the home appliance 400a, and the other end of the first passage 811 may be connected to or contact a sound receiving hole of the first sensor 810. Accordingly, an operation sound signal generated in the internal space of the home appliance 400a may be introduced into the first sensor 810 through the first passage 811. Further, the external sound signal generated in the external space of the home appliance 400a may also pass through, e.g., the housing of the home appliance 400a and be introduced into the first sensor 810 through the first passage 811.

According to an embodiment, the second sensor 820 may be disposed so that an external sound signal generated outside (or in the external space) of the home appliance 400a reaches the second sensor 820 before the first sensor 810. For example, the second sensor 820 may be disposed adjacent to the second passage 821 that is open toward the outside of the home appliance 400a. For example, the second sensor 820 may be disposed adjacent to the other end of the second passage 821 having one end open toward the outside of the home appliance 400a. In this case, the one end of the second passage 821 may be open toward the outside of the home appliance, and the other end of the second passage 821 may be connected to or contact a sound receiving hole of the second sensor 820. Accordingly, a signal corresponding to the external sound generated in the external space of the home appliance 400a may be introduced into the second sensor 820 through the second passage 821. Further, the operation sound signal generated in the internal space of the home appliance 400a may also pass through, e.g., the housing of the home appliance 400a and be introduced into the second sensor 820 through the second passage 821.

According to an embodiment, the sensor assembly 800 may be in a state of being sealed by the housing 840 of the sensor assembly 800 except for the portions corresponding to the first passage 811 and the second passage 821. Accordingly, sound may be introduced into the sensor assembly 800 only through the first passage 811 and the second passage 821 while being prevented from being introduced into the sensor assembly 800 through the remaining portion. Accordingly, the operation sound signal generated inside the home appliance 400a may reach the first sensor 810 before the second sensor 820, and the external sound signal generated outside the home appliance may reach the second sensor 820 before the first sensor 810.

According to an embodiment, the first passage 811 and/or the second passage 821 may have a duct structure or a pipe structure. According to an embodiment, the second passage 821 may pass through at least a portion of the housing of the home appliance 400a.

According to an embodiment, the printed circuit board 830 may be a printed circuit board (PCB), a flexible PCB (FPCB), or a rigid flexible PCB (RFPCB). According to an embodiment, a memory storing at least one instruction and/or at least one processor (e.g., at least one pre-processing processor implementing the pre-processing module 410 of FIG. 4) including a processing circuit may be disposed on the printed circuit board 830. The components disposed on the printed circuit board 830 may be connected to at least one processor and may be controlled by at least one processor.

According to an embodiment, the sensor assembly 800 may be connected to an external component of the sensor assembly 800. For example, the pre-processing module (e.g., the pre-processing module 410 of FIG. 4) of the sensor assembly 800 may be wired to the main-processing module 420 through a connection line (e.g., a cable).

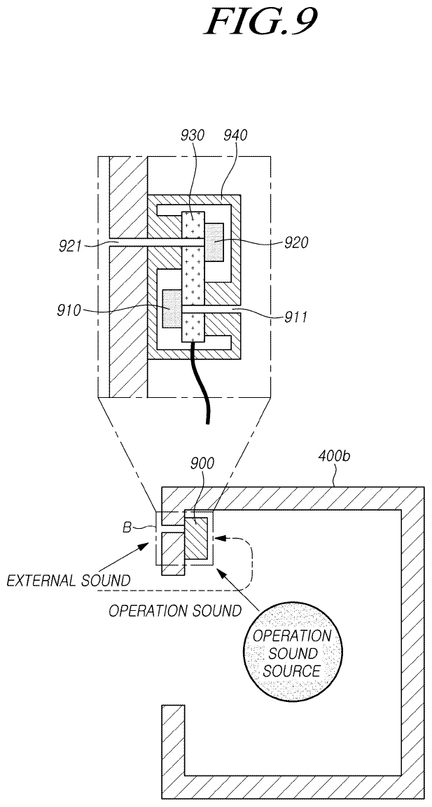

FIG. 9 illustrates a sensor assembly and an arrangement structure of the sensor assembly according to an embodiment of the disclosure.

Referring to FIG. 9, a home appliance 400b (e.g., the home appliance 400) may be a home appliance having an open internal space. For example, the home appliance 400b may be an air conditioner or an air purifier having an open internal space.

According to an embodiment, a sensor assembly 900 may be disposed inside (e.g., inside an upper end) the home appliance 400b. For example, the sensor assembly 900 may be mounted on a portion of the inner surface of the housing of the home appliance 400b.

According to an embodiment, the sensor assembly 900 may include at least two sensors. In the disclosure, the sensor assembly may be referred to as a sensor module.

Referring to the enlarged portion of area B, the sensor assembly 900 may include at least one first sensor 910 (e.g., the first sensor 401 of FIG. 4), at least one second sensor 920 (e.g., the second sensor 402 of FIG. 4), and a printed circuit board 930 on which the first sensor 910 and the second sensor 920 are disposed.

According to an embodiment, the first sensor 910 may be disposed so that an operation sound signal generated inside (or in the internal space) the home appliance 400b reaches the first sensor 910 before the second sensor 920. For example, the first sensor 910 may be disposed adjacent to a first passage 911 that is open toward the inside of the home appliance 400b. For example, the first sensor 910 may be disposed adjacent to the other end of the first passage 911 having one end open toward the inside of the home appliance 400b. In this case, the one end of the first passage 911 may be open toward the inside of the home appliance 400b, and the other end of the first passage 911 may be connected to or contact a sound receiving hole of the first sensor 910. Accordingly, an operation sound signal generated in the internal space of the home appliance 400b may be introduced into the first sensor 910 through the first passage 911. Further, the external sound signal generated in the external space of the home appliance 400b may also pass through, e.g., the open space of the home appliance 400b and be introduced into the first sensor 910 through the first passage 911.

According to an embodiment, the second sensor 920 may be disposed so that an external sound signal generated outside (or in the external space) of the home appliance 400b reaches the second sensor 920 before the first sensor 910. For example, the second sensor 920 may be disposed adjacent to the second passage 921 that is open toward the outside of the home appliance 400b. For example, the second sensor 920 may be disposed adjacent to the other end of the second passage 921 having one end open toward the outside of the home appliance 400b. In this case, the one end of the second passage 921 may be open toward the outside of the home appliance 400b, and the other end of the second passage 921 may be connected to or contact a sound receiving hole of the second sensor 920. Accordingly, a signal corresponding to the external sound generated in the external space of the home appliance 400b may be introduced into the second sensor 920 through the second passage 921. Further, the operation sound signal generated in the internal space of the home appliance 400b may also pass through, e.g., the open space of the home appliance 400b and be introduced into the second sensor 920 through the second passage 921.

According to an embodiment, the sensor assembly 900 may be in a state of being sealed by the housing 940 of the sensor assembly 900 except for the portions corresponding to the first passage 911 and the second passage 921. Accordingly, sound may be introduced into the sensor assembly 900 only through the first passage 911 and the second passage 921 while being prevented from being introduced into the sensor assembly 900 through the remaining portion. Accordingly, the operation sound signal generated inside the home appliance 400b may reach the first sensor 910 before the second sensor 920, and the external sound signal generated outside the home appliance 400b may reach the second sensor 920 before the first sensor 910.

According to an embodiment, the first passage 911 and/or the second passage 921 may have a duct structure or a pipe structure. According to an embodiment, the second passage 921 may pass through at least a portion of the housing of the home appliance 400b.

According to an embodiment, the printed circuit board 930 may be a PCB, an FPCB, or an RFPCB. According to an embodiment, a memory storing at least one instruction and/or at least one processor (e.g., at least one pre-processing processor implementing the pre-processing module 410 of FIG. 4) including a processing circuit may be disposed on the printed circuit board 930. The components disposed on the printed circuit board 930 may be connected to at least one processor and may be controlled by at least one processor.

According to an embodiment, the sensor assembly 900 may be connected to an external component of the sensor assembly 900. For example, the pre-processing module (e.g., the pre-processing module 410 of FIG. 4) of the sensor assembly 900 may be wired to the main-processing module (e.g., the main-processing module 420 of FIG. 4) through a connection line (e.g., a cable).

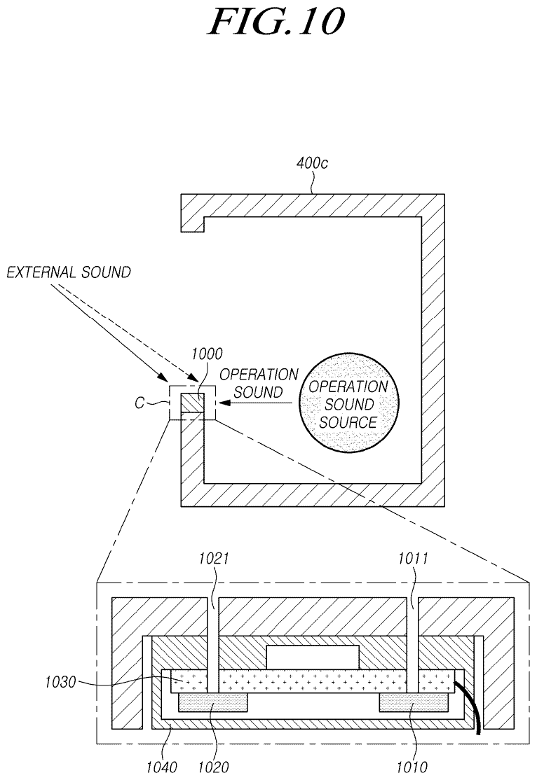

FIG. 10 illustrates a sensor assembly and an arrangement structure of the sensor assembly according to an embodiment of the disclosure.

Referring to FIG. 10, a home appliance 400c (e.g., the home appliance 400) may be a home appliance having an open internal space. For example, the home appliance 400c may be an air conditioner or an air purifier having an open internal space.

According to an embodiment, the sensor assembly 1000 may be disposed in a boundary space between the internal space and external space of the home appliance 400c. For example, the sensor assembly 1000 may be mounted on one surface (e.g., one surface of the inside) of the housing disposed in the boundary space of the home appliance 400c.

According to an embodiment, the sensor assembly 1000 may include at least two sensors. In the disclosure, the sensor assembly may be referred to as a sensor module.

Referring to the enlarged portion of area C, the sensor assembly 1000 may include at least one first sensor 1010 (e.g., the first sensor 401 of FIG. 4), at least one second sensor 1020 (e.g., the second sensor 402 of FIG. 4), and a printed circuit board 1030 on which the first sensor 1010 and the second sensor 1020 are disposed.

According to an embodiment, the first sensor 1010 may be disposed so that an operation sound signal generated inside (or in the internal space) the home appliance 400c reaches the first sensor 1010 before the second sensor 1020. For example, the first sensor 1010 may be disposed adjacent to the first passage 1011 that is open toward the boundary space between the inside and outside of the home appliance 400c. For example, the first sensor 1010 may be disposed adjacent to the other end of the first passage 1011 having one end open toward the boundary space of the home appliance 400c. In this case, the one end of the first passage 1011 may be open toward the boundary space of the home appliance 400c, and the other end of the first passage 1011 may be connected to or contact a sound receiving hole of the first sensor 1010. Accordingly, the sound generated inside or outside the home appliance 400c may be introduced into the first sensor 1010 through the first passage 1011.

According to an embodiment, the second sensor 1020 may be disposed so that an external sound signal generated outside (or in the external space) of the home appliance 400c reaches the second sensor 1020 before the first sensor 1010. According to an embodiment, the second sensor 1020 may be disposed adjacent to the second passage 1021 that is open toward the boundary space between the inside and outside of the home appliance 400c. For example, the second sensor 1020 may be disposed adjacent to the other end of the second passage 1021 having one end open toward the boundary space of the home appliance 400c. In this case, the one end of the second passage 1021 may be open toward the boundary space of the home appliance 400c, and the other end of the second passage 1021 may be connected to or contact a sound receiving hole of the second sensor 1020. Accordingly, the sound generated inside or outside the home appliance 400c may be introduced into the second sensor 1020 through the second passage 1021.

According to an embodiment, the first passage 1011 may be disposed closer to the inside of the home appliance 400c than the second passage 1022 is. The sensor assembly 1000 may be in a state of being sealed by the housing 1040 of the sensor assembly 1000 except for the portions corresponding to the first passage 1011 and the second passage 1021. Accordingly, sound may be introduced into the sensor assembly 1000 only through the first passage 1011 and the second passage 1021 while being prevented from being introduced into the sensor assembly 1000 through the remaining portion. Accordingly, the operation sound signal generated inside the home appliance 400c may reach the first sensor 1010 before the second sensor 1020 through the first passage 1011 disposed closer to the inside of the home appliance 400c than the second passage 1021 is, and the external sound signal generated outside the home appliance 400c may reach the second sensor 1020 before the first sensor 1010 through the second passage 1021 disposed closer to the outside of the home appliance 400c than the first passage 1011 is.

According to an embodiment, the first passage 1011 and/or the second passage 1021 may have a duct structure or a pipe structure. According to an embodiment, the first passage 1011 and/or the second passage 1021 may pass through at least a portion of the housing of the home appliance.

According to an embodiment, the printed circuit board 1030 may be a PCB, an FPCB, or an RFPCB. According to an embodiment, a memory storing at least one instruction and/or at least one processor (e.g., at least one pre-processing processor implementing the pre-processing module 410 of FIG. 4) including a processing circuit may be disposed on the printed circuit board 1030. The components disposed on the printed circuit board 1030 may be connected to at least one processor and may be controlled by at least one processor.

According to an embodiment, the sensor assembly 1000 may be connected to an external component of the sensor assembly 1000. For example, the pre-processing module (e.g., the pre-processing module 410 of FIG. 4) of the sensor assembly 1000 may be wired to the main-processing module (e.g., the main-processing module 420 of FIG. 4) through a connection line (e.g., a cable).

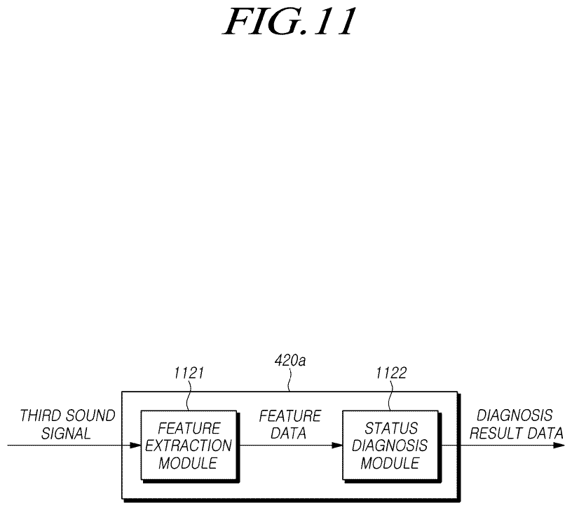

FIG. 11 illustrates an example configuration of a main-processing module according to an embodiment of the disclosure.

The main-processing module 420a of the embodiment of FIG. 11 may be an example of the main-processing module 420 of FIG. 4.

Referring to FIG. 11, the main-processing module 420a may include a feature extraction module 1121 and a status diagnosis module 1122.

According to an embodiment, the main-processing module 420a may obtain a third sound signal. For example, the main-processing module 420a may receive, from the pre-processing module, the third sound signal generated by the pre-processing module (e.g., the pre-processing module 410 of FIG. 4, the pre-processing module 410a of FIG. 5, the pre-processing module 410b of FIG. 6, or the pre-processing module 410c of FIG. 7). For description of the generation of the third sound signal by the pre-processing module, e.g., the description of FIGS. 4 to 7 may be referred to.

According to an embodiment, the main-processing module 420a may obtain data (hereinafter, referred to as status-related data) related to the status of the home appliance (e.g., the home appliance 400 of FIG. 4, the home appliance 400a of FIG. 8, the home appliance 400b of FIG. 9, or the home appliance 400c of FIG. 10), based on the third sound signal. For example, the main-processing module 420a may generate the status-related data using the third sound signal of at least one time step.

According to an embodiment, the status-related data may include feature data for diagnosing the status of the home appliance and/or diagnosis result data obtained based on the feature data. The feature data may include, e.g., a value of at least one feature used to diagnose the status of the home appliance. The diagnosis result data may include, e.g., first result data including a result of diagnosing the status of the home appliance based on the feature data and/or second result data including a result of comprehensively determining the status of the home appliance based on the first result data.

According to an embodiment, the feature extraction module 1121 may obtain at least one piece of feature data, based on at least one third sound signal. For example, the feature extraction module 1121 may generate feature data of each corresponding time step using the value of the third sound signal of each time step.

According to an embodiment, the status diagnosis module 1122 may obtain at least one piece of first result data based on the at least one piece of feature data. The first result data may include, e.g., first information indicating whether the status of the home appliance is normal or abnormal and/or second information indicating the cause or type of abnormality when the status of the home appliance is abnormal.

According to an embodiment, the status diagnosis module 1122 may perform an inference operation using a trained AI model to obtain the first result data. For example, the status diagnosis module 1122 may input at least one piece of feature data to the AI model as input data, and obtain the at least one piece of first result data as output data of the AI model. The status diagnosis module 1122 may generate one first result data for each feature data, or may generate one first result data for a plurality of feature data.

According to an embodiment, the status diagnosis module 1122 may obtain second result data, based on at least one first result data. For example, the status diagnosis module 1122 may generate the second result data including the result of comprehensively determining the status of the home appliance by analyzing the history of diagnosing the status of the home appliance using the at least one first result data.

According to an embodiment, the home appliance may transmit the status-related data to an external electronic device (e.g., a server) through a communication module. The external electronic device to which the status-related data is transmitted may be, e.g., a server to which the home appliance is registered. The status-related data may include diagnosis result data.

According to an embodiment, when the status-related data transmitted to the external electronic device includes the diagnosis result data, the external electronic device may update the status information about the home appliance based on the diagnosis result data.

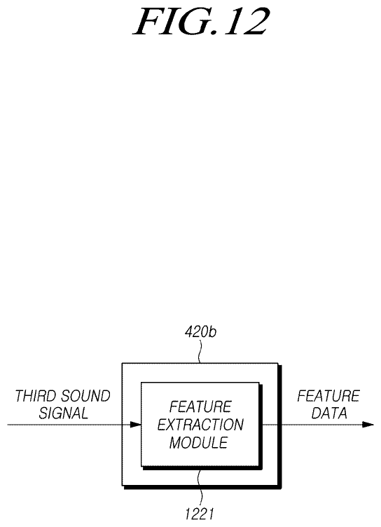

FIG. 12 illustrates an example configuration of a main-processing module according to an embodiment of the disclosure.

The main-processing module 420b of the embodiment of FIG. 12 may be an example of the main-processing module 420 of FIG. 4.

Referring to FIG. 12, the main-processing module 420b may include a feature extraction module 1221. Unlike the main processing module 420a of FIG. 11, the main-processing module 420b of FIG. 12 does not include a status diagnosis module. Accordingly, the same processing as the processing by the status diagnosis module 1122 of FIG. 11 may be performed by an external electronic device (e.g., a server).

According to an embodiment, the main-processing module 420b may obtain a third sound signal. For example, the main-processing module 420b may receive, from the pre-processing module, the third sound signal generated by the pre-processing module (e.g., the pre-processing module 410 of FIG. 4, the pre-processing module 410a of FIG. 5, the pre-processing module 410b of FIG. 6, or the pre-processing module 410c of FIG. 7). For description of the generation of the third sound signal by the pre-processing module, e.g., the description of FIGS. 4 to 7 may be referred to.

According to an embodiment, the main-processing module 420b may obtain data (hereinafter, referred to as status-related data) related to the status of the home appliance (e.g., the home appliance 400 of FIG. 4, the home appliance 400a of FIG. 8, the home appliance 400b of FIG. 9, or the home appliance 400c of FIG. 10), based on the third sound signal. For example, the main-processing module 420b may generate the status-related data using the third sound signal of at least one time step.

According to an embodiment, the status-related data may include feature data for diagnosing the status of the home appliance. The feature data may include, e.g., a value of at least one feature used to diagnose the status of the home appliance.

According to an embodiment, the feature extraction module 1221 may obtain at least one piece of feature data, based on at least one third sound signal. For example, the feature extraction module 1221 may generate feature data of each corresponding time step using the value of the third sound signal of each time step.

According to an embodiment, the home appliance may transmit the status-related data to an external electronic device (e.g., a server) through a communication module. The external electronic device to which the status-related data is transmitted may be, e.g., a server to which the home appliance is registered. The status-related data may include feature data.

According to an embodiment, when the status-related data transmitted to the external electronic device includes feature data, the external electronic device may obtain diagnosis result data based on the feature data. In this case, the main-processing module 420b may transmit the feature data itself to the external electronic device without performing the operation of obtaining the diagnosis result data based on the above-described feature data, and the external electronic device may obtain the diagnosis result data based on the received feature data. The external electronic device may update the status information about the home appliance based on the diagnosis result data.

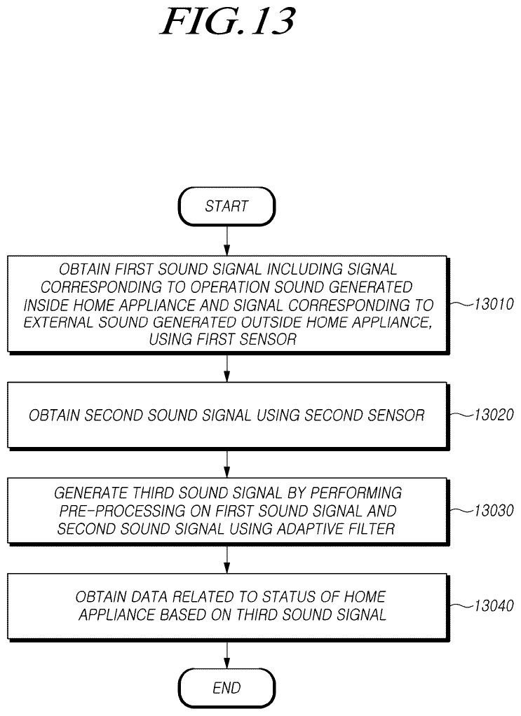

FIG. 13 is a flowchart illustrating a method for operating a home appliance according to an embodiment of the disclosure.

According to an embodiment, a home appliance (e.g., the home appliance 400 of FIG. 4, the home appliance 400a of FIG. 8, the home appliance 400b of FIG. 9, or the home appliance 400c of FIG. 10) may include a sensor assembly (e.g., the sensor assembly 800 of FIG. 8, the sensor assembly 900 of FIG. 9, or the sensor assembly 1000 of FIG. 10) including a first sensor and a second sensor, a memory including at least one instruction, and/or at least one processor including a processing circuit.

Referring to FIG. 13, in operation 13010, the home appliance may obtain a first sound signal including a signal corresponding to an operation sound generated inside (or in an internal space) the home appliance and a signal corresponding to an external sound generated outside the home appliance using the first sensor (e.g., the first sensor 401 of FIG. 4, the first sensor 810 of FIG. 8, the first sensor 910 of FIG. 9, or the first sensor 1010 of FIG. 10).

In operation 13020, the home appliance may obtain a second sound signal using the second sensor (e.g., the second sensor 402 of FIG. 4, the second sensor 820 of FIG. 8, the second sensor 920 of FIG. 9, or the second sensor 1020 of FIG. 10).

According to an embodiment, the second sound signal may have a correlation with the signal corresponding to the external sound of the home appliance included in the first sound signal. For example, the second sound signal may include a signal corresponding to an external sound generated by the same sound source as the sound source of the signal corresponding to the external sound of the home appliance included in the first sound signal. The signal corresponding to the external sound generated by the corresponding sound source may reach the second sensor before the first sensor, and may have a higher signal strength (or intensity).

According to an embodiment, the first sensor may be disposed adjacent to the other end of a first passage (e.g., the first passage 811 of FIG. 8 or the first passage 911 of FIG. 9) having one end open toward the inside of the home appliance, and the second sensor may be disposed adjacent to the other end of a second passage (e.g., the second passage 821 of FIG. 8 or the second passage 921 of FIG. 9) having one end open toward the outside of the home appliance.

According to an embodiment, the first sensor may be disposed adjacent to the other end of a first passage (e.g., the first passage 1011 of FIG. 10) having one end open toward a boundary space between the inside and the outside of the home appliance, the second sensor may be disposed adjacent to the other end of a second passage (e.g., the second passage 1021 of FIG. 10) having one end open toward the corresponding boundary space, and the first passage may be disposed closer to the inside of the home appliance than the second passage is.

In operation 13030, the home appliance may generate a third sound signal by performing pre-processing on the first sound signal and the second sound signal using an adaptive filter (e.g., the adaptive filter 512 of FIG. 5, the adaptive filter 612 of FIG. 6, or the adaptive filter 712 of FIG. 7).

According to an embodiment, the pre-processing operation for the first sound signal and the second sound signal using the adaptive filter may include, e.g., a pre-processing operation by the pre-processing module 410 of FIG. 4, a pre-processing operation by the pre-processing module 410a of FIG. 5, a pre-processing operation by the pre-processing module 410b of FIG. 6, or a pre-processing operation by the pre-processing module 410c of FIG. 7.

According to an embodiment, the filter coefficient of the adaptive filter may be updated using an adaptive algorithm configured based on the third sound signal and the second sound signal. The filter coefficient of the adaptive filter may converge to the value of the transfer function illustrated in Equation 6 described above. The filter coefficient W of the adaptive filter may be updated to minimize, e.g., a correlation between the second sound signal and the third sound signal.

According to an embodiment, the adaptive filter may be an FIR filter, and the adaptive algorithm may be an LMS algorithm.

According to an embodiment, the filter coefficient of the adaptive filter may be updated using Equation 5, Equation 8, or Equation 10 described above.

According to an embodiment, the sensor assembly may be disposed inside the housing, and may include a first printed circuit board (e.g., the printed circuit board 830 of FIG. 8, the printed circuit board 930 of FIG. 9, or the printed circuit board 1030 of FIG. 10) on which the first sensor and the second sensor are disposed.

According to an embodiment, the at least one processor may include at least one first processor (e.g., a pre-processing processor implementing the pre-processing modules 410, 410a, 410b, and 410c) disposed on the first printed circuit board and at least one second processor (e.g., a main-processing processor implementing the main-processing modules 420, 420a, 420b, and 420c) disposed on the second printed circuit board disposed outside the sensor assembly.

According to an embodiment, the third sound signal may be generated by the first processor and transferred to the second processor, and the first sound signal and the second sound signal may not be transferred to the second processor. As such, since only the third sound signal where the external sound signal related to the user's privacy is removed or reduced is transferred to the second processor, but the first sound signal and the second sound signal including the external sound signal related to the user's privacy are not transferred to the second processor, the user's privacy may be guaranteed.

In operation 13040, the home appliance may obtain data (status-related data) related to the status of the home appliance based on the third sound signal.

According to an embodiment, the status-related data may include feature data for diagnosing the status of the home appliance and/or diagnosis result data obtained based on the feature data. The feature data may include, e.g., a value of at least one feature used to diagnose the status of the home appliance. The diagnosis result data may include, e.g., first result data including a result of diagnosing the status of the home appliance based on the feature data and/or second result data including a result of comprehensively determining the status of the home appliance based on the first result data.

According to an embodiment, the home appliance may transmit the status-related data to an external electronic device (e.g., a server) through a communication module (e.g., a wireless communication module). The external electronic device to which the status-related data is transmitted may be, e.g., a server to which the home appliance is registered.

According to an embodiment, the communication module for communication with the external electronic device may be disposed on the second printed circuit board disposed outside the sensor assembly. The first printed circuit board may not include a communication module for communication with the external electronic device. Accordingly, the first sound signal and the second sound signal including the external sound signal related to the user's privacy may not be exposed to the outside.

According to an embodiment, when the status-related data transmitted to the external electronic device includes feature data, the external electronic device may obtain diagnosis result data based on the feature data. In this case, the home appliance may transmit the feature data itself to the external electronic device without performing the operation of obtaining the diagnosis result data based on the above-described feature data, and the external electronic device may obtain the diagnosis result data based on the received feature data. The external electronic device may update the status information about the home appliance based on the diagnosis result data.

According to an embodiment, when the status-related data transmitted to the external electronic device includes the diagnosis result data, the external electronic device may update the status information about the home appliance based on the diagnosis result data.

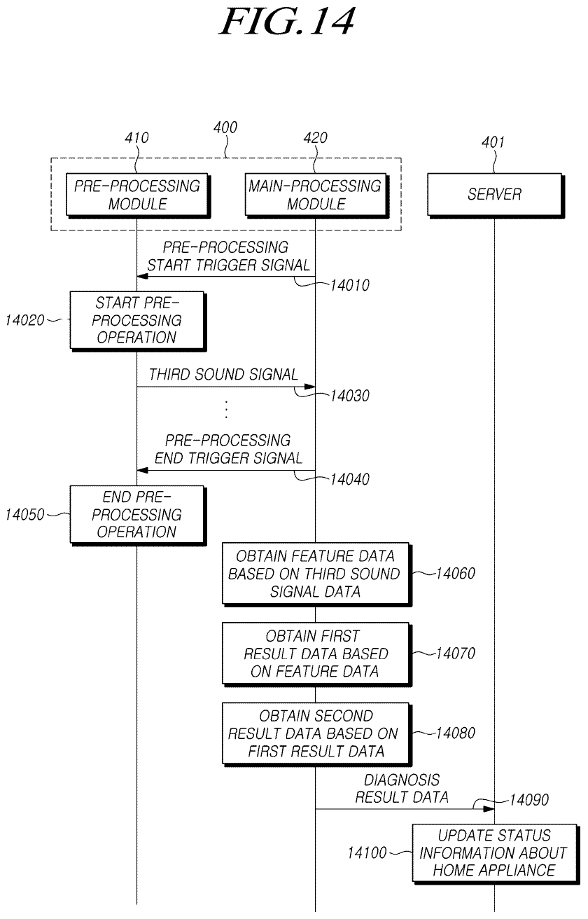

FIG. 14 is a signal flowchart illustrating a procedure for diagnosing a status of a home appliance according to an embodiment of the disclosure.

According to an embodiment, a home appliance 400 (e.g., the home appliance 400a of FIG. 8, the home appliance 400b of FIG. 9, or the home appliance 400c of FIG. 10) may include a pre-processing module 410 (e.g., the pre-processing module 410a of FIG. 5, the pre-processing module 410b of FIG. 6, or the pre-processing module 410c of FIG. 7) and a main-processing module 420 (e.g., the main-processing module 420a of FIG. 5, the main-processing module 420b of FIG. 6, or the main-processing module 420c of FIG. 7).

Referring to FIG. 14, in operation 14010, the main-processing module 420 may transmit a pre-processing start trigger signal triggering the start of the pre-processing operation to the pre-processing module 410.

According to an embodiment, the main-processing module 420 may transmit the pre-processing start trigger signal to the pre-processing module 410 when the home appliance 400 starts operating or a set specific condition is met. For example, when the home appliance 400 is a washer, the main-processing module 420 may transmit a pre-processing start trigger signal to the pre-processing module 410 when the spin cycle of the washer starts or when a set time elapses after the spin cycle starts.

In operation 14020, the pre-processing module 410 may start the pre-processing operation in response to receiving the pre-processing start trigger signal. According to an embodiment, the pre-processing operation may include at least one operation for generating a third sound signal based on the first sound signal and the second sound signal using the adaptive filter. For description of the pre-processing operation, the description made above in connection with FIGS. 4 to 7 may be referred to.

In operation 14030, the pre-processing module 410 may transmit at least one third sound signal to the main-processing module. According to an embodiment, the pre-processing module 410 may transmit the third sound signal obtained by performing the pre-processing operation in each time step to the main-processing module 420. The main-processing module 420 may store the received third sound signal.

In operation 14040, the main-processing module 420 may transmit a pre-processing end trigger signal triggering the end of the pre-processing operation to the pre-processing module 410.

According to an embodiment, the main-processing module 420 may transmit the pre-processing end trigger signal to the pre-processing module 410 when the home appliance 400 ends operation or a set specific condition is met. For example, when the home appliance 400 is a washer, the main-processing module 420 may transmit a pre-processing end trigger signal to the pre-processing module 410 when the spin cycle of the washer ends or when a set time elapses after the spin cycle starts.

In operation 14050, the pre-processing module 410 may end the pre-processing operation in response to receiving the pre-processing end trigger signal.

In operation 14060, the main-processing module 420 may obtain feature data, based on the data of the third sound signal. In operation 14070, the main-processing module 420 may obtain first result data based on the feature data. In operation 14080, the main-processing module 420 may obtain second result data based on the first result data. For description of the operation of the main-processing module 420 for obtaining the feature data, the first result data, and/or the second result data, the description of FIGS. 4, 11, and 12 may be referred to.

In operation 14090, the main-processing module 420 may transmit the diagnosis result data to the server.

According to an embodiment, the diagnosis result data may include, e.g., first result data including a result of diagnosing the status of the home appliance based on the feature data and/or second result data including a result of comprehensively determining the status of the home appliance based on the first result data.

According to an embodiment, the main-processing module 420 may finally determine whether there is an abnormality in the home appliance 400 based on the first result data and/or the second result data and, when it is identified that there is an abnormality in the home appliance 400, transmit the diagnosis result data to the server 401. When it is identified that there is no abnormality in the home appliance, the main-processing module 420 may not transmit the diagnosis result data to the server 401.

In operation 14100, the server 401 may update the status information about the home appliance 400 in response to the diagnosis result data being received.

According to an embodiment, the server 401 may be a server in which the home appliance 400 is registered.

According to an embodiment, the server 401 may store the updated status information about the home appliance 400 in association with the account information about the user of the home appliance 400.

According to an embodiment, when it is identified that there is an abnormality in the home appliance 400, the server 401 may transmit status information about the home appliance to a server associated with a service center responsible for repairing the home appliance. Accordingly, reception for repairing the abnormal home appliance 400 may be quickly performed.

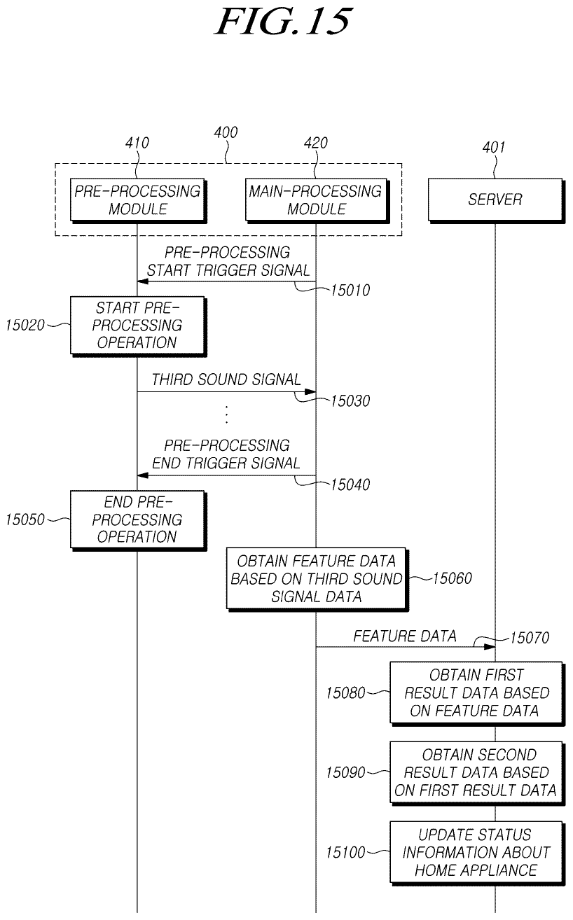

FIG. 15 is a signal flowchart illustrating a procedure for diagnosing a status of a home appliance according to an embodiment of the disclosure.

In the embodiment of FIG. 15, unlike the embodiment of FIG. 14 in which the diagnosis result data is generated by the home appliance 400, the diagnosis result data may be generated by the server 401.

According to an embodiment, a home appliance 400 (e.g., the home appliance 400a of FIG. 8, the home appliance 400b of FIG. 9, or the home appliance 400c of FIG. 10) may include a pre-processing module 410 (e.g., the pre-processing module 410a of FIG. 5, the pre-processing module 410b of FIG. 6, or the pre-processing module 410c of FIG. 7) and a main-processing module 420 (e.g., the main-processing module 420a of FIG. 5, the main-processing module 420b of FIG. 6, or the main-processing module 420c of FIG. 7).

Referring to FIG. 15, in operation 15010, the main-processing module 420 may transmit a pre-processing start trigger signal triggering the start of the pre-processing operation to the pre-processing module 410.

According to an embodiment, the main-processing module 420 may transmit the pre-processing start trigger signal to the pre-processing module 410 when the home appliance 400 starts operating or a set specific condition is met. For example, when the home appliance 400 is a washer, the main-processing module 420 may transmit a pre-processing start trigger signal to the pre-processing module 410 when the spin cycle of the washer starts or when a set time elapses after the spin cycle starts.

In operation 15020, the pre-processing module 410 may start the pre-processing operation in response to receiving the pre-processing start trigger signal. According to an embodiment, the pre-processing operation may include at least one operation for generating a third sound signal based on the first sound signal and the second sound signal using the adaptive filter. For description of the pre-processing operation, the description made above in connection with FIGS. 4 to 7 may be referred to.

In operation 15030, the pre-processing module 410 may transmit at least one third sound signal to the main-processing module. According to an embodiment, the pre-processing module 410 may transmit the third sound signal obtained by performing the pre-processing operation in each time step to the main-processing module 420. The main-processing module 420 may store the data of the received third sound signal.

In operation 15040, the main-processing module 420 may transmit a pre-processing end trigger signal triggering the end of the pre-processing operation to the pre-processing module 410.

According to an embodiment, the main-processing module 420 may transmit the pre-processing end trigger signal to the pre-processing module 410 when the home appliance 400 ends operation or a set specific condition is met. For example, when the home appliance 400 is a washer, the main-processing module 420 may transmit a pre-processing end trigger signal to the pre-processing module 410 when the spin cycle of the washer ends or when a set time elapses after the spin cycle starts.

In operation 15050, the pre-processing module 410 may end the pre-processing operation in response to receiving the pre-processing end trigger signal.

In operation 15060, the main-processing module 420 may obtain feature data, based on the data of the third sound signal. As such, in the embodiment of FIG. 15, unlike the embodiment of FIG. 14, the home appliance 400 does not perform an operation of generating diagnosis result data based on the feature data. For example, the home appliance (or the main-processing module of the home appliance) may be a device that does not have high computing power. In this case, it may be burdensome for the home appliance to generate the diagnosis result data based on the feature data, e.g., through inference using a trained AI model. Accordingly, the corresponding home appliance may transmit the feature data itself to the server through operation 15070 below, so that the server 401 having higher computing capability than the corresponding home appliance may generate the diagnosis result data based on the feature data.

In operation 15070, the main-processing module 420 may transmit the feature data to the server 401. According to an embodiment, the server 401 may be a server in which the home appliance is registered.

In operation 15080, the server 401 may obtain first result data based on the feature data. In operation 15090, the server 401 may obtain second result data based on the first result data. The operation of the server 401 for obtaining the first result data and/or the second result data may be substantially the same as the operation for obtaining the first result data and/or the second result data of the main-processing modules 420 and 420a of FIGS. 4 and 11. For example, the operation of the server 401 for obtaining the first result data and/or the second result data may be substantially the same as the operation of the status diagnosis module 1122 of the main-processing module 420a of FIG. 11.

In operation 15100, the server 401 may update the status information about the home appliance 400 based on the first result data and/or the second result data.

According to an embodiment, the server 401 may store the updated status information about the home appliance in association with the account information about the user of the home appliance 400.

According to an embodiment, when it is identified that there is an abnormality in the home appliance 400, the server 401 may transmit status information about the home appliance to a server associated with a service center responsible for repairing the home appliance. Accordingly, reception for repairing the abnormal home appliance 400 may be quickly performed.

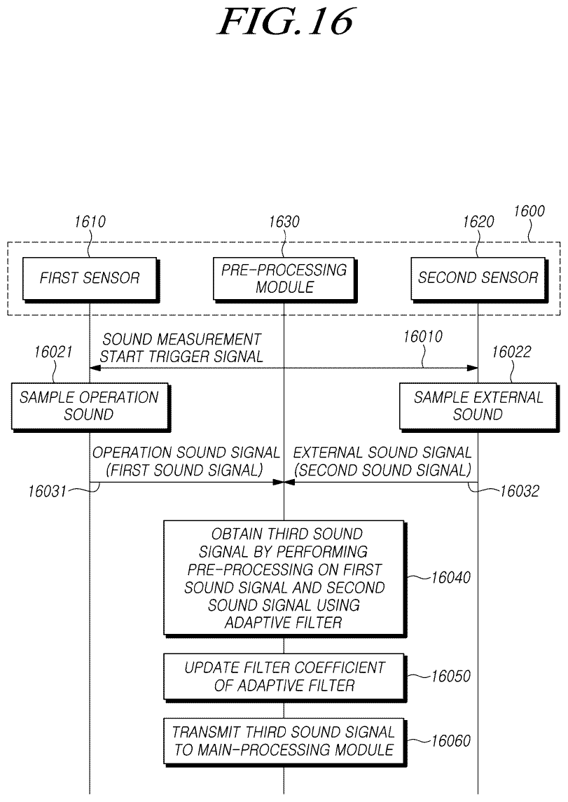

FIG. 16 is a signal flowchart illustrating a pre-processing procedure of a home appliance according to an embodiment of the disclosure.

According to an embodiment, a home appliance 1600 (e.g., the home appliance 400 of FIG. 4, the home appliance 400a of FIG. 8, the home appliance 400b of FIG. 9, or the home appliance 400c of FIG. 10) may include a sensor assembly (e.g., the sensor assembly 800 of FIG. 8, the sensor assembly 900 of FIG. 9, or the sensor assembly 1000 of FIG. 10) including a first sensor, a second sensor, and a pre-processing module. The sensor assembly may perform the pre-processing procedure of FIG. 16.

Referring to FIG. 16, in operation 16010, the pre-processing module 1630 (e.g., the pre-processing module 410 of FIG. 4, the pre-processing module 410a of FIG. 5, the pre-processing module 410b of FIG. 6, or the pre-processing module 410c of FIG. 7) may transmit a sound measurement start trigger signal for triggering the start of measurement of sound to the first sensor 1610 (e.g., the first sensor 401 of FIG. 4, the first sensor 810 of FIG. 8, the first sensor 910 of FIG. 9, or the first sensor 1010 of FIG. 10) and the second sensor 1620 (e.g., the second sensor 402 of FIG. 4, the second sensor 820 of FIG. 8, the second sensor 920 of FIG. 9, or the second sensor 1020 of FIG. 10).

In operation 16021, the first sensor 1610 may sample the first sound signal including the operation sound signal generated inside (or in the internal space) the home appliance 1600, based on receiving the sound measurement start trigger signal. According to an embodiment, the first sensor 1610 may sample the first sound signal at a set sampling period.

In operation 16022, the second sensor 1620 may sample the second sound signal including the external sound signal generated outside (or in the external space) the home appliance 1600, based on receiving the sound measurement start trigger signal. According to an embodiment, the second sensor 1620 may sample the second sound signal at a set sampling period. Operation 16021 and operation 16022 may be performed in parallel or together.

According to an embodiment, the sampling start time and the sampling period for sampling the first sound signal may be the same as the sampling start time and the sampling period for sampling the second sound signal.

In operation 16031, the first sensor 1610 may transmit data of the first sound signal obtained through the operation sound sampling operation of operation 16021 to the pre-processing module 1630. In operation 16032, the second sensor 1620 may transmit data of the second sound signal obtained through the external sound sampling operation of operation 16022 to the pre-processing module 1630. Operation 16031 and operation 16032 may be performed in parallel or together.

In operation 16040, the pre-processing module 1630 may obtain a third sound signal by performing pre-processing on the first sound signal and the second sound signal using an adaptive filter (e.g., the adaptive filter 512 of FIG. 5, the adaptive filter 612 of FIG. 6, or the adaptive filter 712 of FIG. 7). For description of the pre-processing operation for obtaining the third sound signal, the description made above with reference to FIGS. 4 to 7 or the description made below with reference to FIGS. 17 and 18 may be referred to.

In operation 16050, the pre-processing module 1630 may update the filter coefficient of the adaptive filter. According to an embodiment, the filter coefficient of the adaptive filter may be updated using Equation 5, Equation 8, or Equation 10 described above.

In operation 16060, the pre-processing module 1630 may transmit the third sound signal to the main-processing module (e.g., the main-processing module 420 of FIG. 4, the main-processing module 420a of FIG. 5, the main-processing module 420b of FIG. 6, or the main-processing module 420c of FIG. 7). According to an embodiment, operation 16060 may be performed in parallel with or together with operation 16050, or may be performed before operation 16050.

FIG. 17 is a flowchart illustrating a pre-processing operation of a home appliance according to an embodiment of the disclosure.

The pre-processing operation of the home appliance of FIG. 17 (e.g., the home appliance 400 of FIG. 4, the home appliance 400a of FIG. 8, the home appliance 400b of FIG. 9, the home appliance 400c of FIG. 10, or the home appliance 1600 of FIG. 16) may be performed, e.g., by the pre-processing module 410a of FIG. 5. For description of the pre-processing operation of FIG. 17, the description of the pre-processing operation by the pre-processing module 410a of FIG. 5 may be referred to.

According to an embodiment, the home appliance may obtain a first sound signal using a first sensor (e.g., the first sensor 401 of FIG. 4, the first sensor 810 of FIG. 8, the first sensor 910 of FIG. 9, the first sensor 1010 of FIG. 10, or the first sensor 1610 of FIG. 16), and may obtain a second sound signal using a second sensor (e.g., the second sensor 402 of FIG. 4, the second sensor 820 of FIG. 8, the second sensor 920 of FIG. 9, the second sensor 1020 of FIG. 10, or the second sensor 1620 of FIG. 16).

Referring to FIG. 17, in operation 17010, the home appliance may obtain (or generate) a pre-filtered first sound signal by pre-filtering the first sound signal using a pre-filter.

In operation 17020, the home appliance may obtain (or generate) a fourth sound signal using the pre-filtered first sound signal and the second sound signal.

In operation 17030, the home appliance may generate a filtered fourth sound signal by filtering the fourth sound signal using the adaptive filter.

In operation 17040, the home appliance may generate a third sound signal using the first sound signal and the filtered fourth sound signal.

FIG. 18 is a flowchart illustrating a pre-processing operation of a home appliance according to an embodiment of the disclosure.

The pre-processing operation of the home appliance of FIG. 18 (e.g., the home appliance 400 of FIG. 4, the home appliance 400a of FIG. 8, the home appliance 400b of FIG. 9, the home appliance 400c of FIG. 10, or the home appliance 1600 of FIG. 16) may be performed, e.g., by the pre-processing module 410b of FIG. 6. For description of the pre-processing operation of FIG. 18, the description of the pre-processing operation by the pre-processing module 410b of FIG. 6 may be referred to.

According to an embodiment, the home appliance may obtain a first sound signal using a first sensor (e.g., the first sensor 401 of FIG. 4, the first sensor 810 of FIG. 8, the first sensor 910 of FIG. 9, the first sensor 1010 of FIG. 10, or the first sensor 1610 of FIG. 16), and may obtain a second sound signal using a second sensor (e.g., the second sensor 402 of FIG. 4, the second sensor 820 of FIG. 8, the second sensor 920 of FIG. 9, the second sensor 1020 of FIG. 10, or the second sensor 1620 of FIG. 16).

Referring to FIG. 18, in operation 18010, the home appliance may obtain a pre-filtered first sound signal by pre-filtering the first sound signal using a pre-filter.

In operation 18020, the home appliance may generate a pre-filtered second sound signal by pre-filtering the second sound signal using the second pre-filter.

In operation 18030, the home appliance may generate a filtered second sound signal by filtering the pre-filtered second sound signal using the adaptive filter. Operation 18010 and operation 18020/18030 may be performed in parallel or together.

In operation 18040, the home appliance may generate a third sound signal using the pre-filtered first sound signal and the filtered second sound signal.

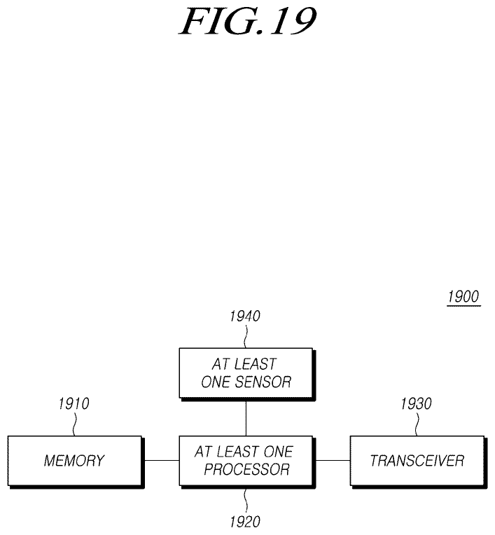

FIG. 19 illustrates an example configuration of a home appliance according to an embodiment of the disclosure.

Referring to FIG. 19, a home appliance 1900 (e.g., the home appliance 400 of FIG. 4, the home appliance 400a of FIG. 8, the home appliance 400b of FIG. 9, the home appliance 400c of FIG. 10, or the home appliance 1600 of FIG. 16) may include a memory 1910, at least one processor 1920, a transceiver (or communication module) 1930, and/or at least one sensor 1940. According to an example, the home appliance 1900 may include an additional component (e.g., a display, an audio output unit (or a speaker), or a communication interface for communication with a remote controller) in addition to the illustrated component, or omit at least one of the illustrated components.

According to an embodiment, the memory 1910 may store various pieces of information or data associated with the operation of the home appliance 1900. For example, the memory 1910 may include one or more storage media storing at least one instruction. For example, the memory 1910 may include first instructions that, when individually or collectively executed by at least one processor 1920, enable the home appliance 1900 to perform the operation(s) of the pre-processing module (e.g., the pre-processing module 410 of FIG. 4, the pre-processing module 410a of FIG. 5, the pre-processing module 410b of FIG. 6, the pre-processing module 410c of FIG. 7, or the pre-processing module 1630 of FIG. 16). For example, the memory 1910 may include second instructions that, when individually or collectively executed by at least one processor 1920, enable the home appliance 1900 to perform the operation(s) of the main-processing module (e.g., the main-processing module 420 of FIG. 4, the main-processing module 420a of FIG. 11, or the main-processing module 420b of FIG. 12). For example, the memory 1910 may include the first instructions and the second instructions described above.

According to an embodiment, the at least one processor 1920 may be electrically or operatively connected to the memory 1910, the transceiver 1930, and the at least one sensor 1940. The at least one processor 1920 may include a processing circuit for executing at least one instruction stored in the memory 1910.

According to an embodiment, the at least one processor 1920 may include various processing circuits and/or multiple processors. One or more of the at least one processor 1920 may be configured to individually and/or collectively perform various functions described in the disclosure. In the disclosure, when it is described that “processor”, “at least one processor”, and “one or more processors” are configured to perform numerous functions, these terms may cover, e.g., a situation in which one processor performs some of the cited functions and another processor(s) performs other some of the cited functions, and may also cover a situation in which a single processor may perform all of the cited functions, but embodiments of the disclosure are not limited thereto. Additionally, the at least one processor 1920 may include, e.g., a combination of processors performing various functions cited/initiated in a distributed manner. The at least one processor 1920 may execute program instructions to achieve or perform various functions.

According to an embodiment, at least one processor 1920 may include at least one of a central processing unit (CPU), a neural processing unit (NPU), a graphics processing unit (GPU), a micro processing unit (MPU), a micro controller unit (MCU), an application processor (AP), a communication processor (CP), a system on chip (SoC), or an integrated circuit (IC) sensor hub, a supplementary processor, a communication processor), an application processor, an application specific integrated circuit (ASIC), or a field programmable gate arrays (FPGA), and may include a plurality of cores.

According to an embodiment, the at least one processor 1920 may include at least one first processor (a pre-processing processor) for implementing a pre-processing module (e.g., the pre-processing module 410 of FIG. 4, the pre-processing module 410a of FIG. 5, the pre-processing module 410b of FIG. 6, the pre-processing module 410c of FIG. 7, or the pre-processing module 1630 of FIG. 16), and/or at least one second processor (a main-processing processor) for implementing a main-processing module (e.g., the main-processing module 420 of FIG. 4, the main-processing module 420a of FIG. 11, or the main-processing module 420b of FIG. 12).

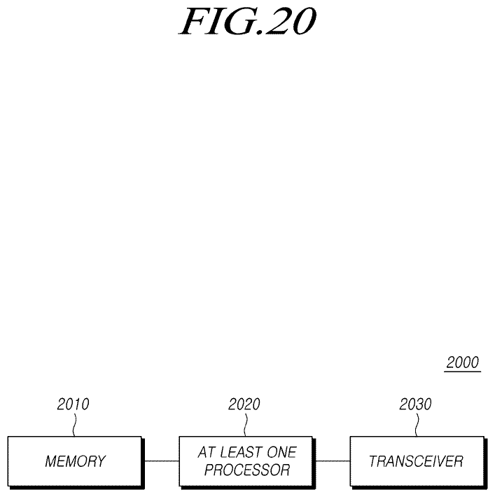

According to an embodiment, the transceiver 1930 may support wired or wireless communication between the home appliance 1900 and an external electronic device (e.g., the server 401 of FIGS. 14 and 15 or the server 2000 of FIG. 20). The wireless communication scheme may include, e.g., an LTE scheme, a 5G NR scheme, a Wi-Fi scheme, Bluetooth, Bluetooth low energy, infrared data association (IrDA), ultra-wideband (UWB), and near-field communication (NFC).

According to an embodiment, at least one sensor 1940 may detect an operational state (e.g., power or temperature) of the home appliance 1900 or an external environmental state (e.g., the user's state), and then generate an electrical signal or data value corresponding to the detected state. The at least one sensor 1940 may include, e.g., a sound sensor, a gesture sensor, a gyro sensor, an atmospheric pressure sensor, a magnetic sensor, an acceleration sensor, a grip sensor, a proximity sensor, a color sensor, an infrared (IR) sensor, a bio sensor, a temperature sensor, a humidity sensor, or an illuminance sensor.

According to an embodiment, the at least one sensor 1940 may include a first sensor (e.g., the first sensor 401 of FIG. 4, the first sensor 810 of FIG. 8, the first sensor 910 of FIG. 9, the first sensor 1010 of FIG. 10, or the first sensor 1610 of FIG. 16) and a second sensor (e.g., the second sensor 402 of FIG. 4, the second sensor 820 of FIG. 8, the second sensor 920 of FIG. 9, the second sensor 1020 of FIG. 10, or the second sensor 1620 of FIG. 16) for detecting and/or measuring sound.

FIG. 20 illustrates an example configuration of a server according to an embodiment of the disclosure.

Referring to FIG. 20, a server 2000 (e.g., the server 401 of FIGS. 14 and 15) may include a memory 2010, at least one processor 2020, and/or a transceiver (or communication module) 2030. According to an example, the server 2000 may include an additional component (e.g., a display, an audio output unit (or a speaker), or a communication interface for communication with a remote controller) in addition to the illustrated component, or omit at least one of the illustrated components.

According to an embodiment, the memory 2010 may store various pieces of information or data associated with the operation of the server 2000. For example, the memory 2010 may include one or more storage media storing at least one instruction. For example, the memory 2010 may include instructions that, when individually or collectively executed by at least one processor 2020, enable the server 2000 to perform an operation(s).

According to an embodiment, the at least one processor 2020 may be electrically or operatively connected to the memory 2010 and the transceiver 2030. The at least one processor 2020 may include a processing circuit for executing at least one instruction stored in the memory 2010.

According to an embodiment, the at least one processor 2020 may include various processing circuits and/or multiple processors. One or more of the at least one processor 2020 may be configured to individually and/or collectively perform various functions described in the disclosure. In the disclosure, when it is described that “processor”, “at least one processor”, and “one or more processors” are configured to perform numerous functions, these terms may cover, e.g., a situation in which one processor performs some of the cited functions and another processor(s) performs other some of the cited functions, and may also cover a situation in which a single processor may perform all of the cited functions, but embodiments of the disclosure are not limited thereto. Additionally, the at least one processor 2020 may include, e.g., a combination of processors performing various functions cited/initiated in a distributed manner. The at least one processor 2020 may execute program instructions to achieve or perform various functions.

According to an embodiment, the at least one processor 2020 may include at least one of a CPU, an NPU, a GPU, an MPU, an MCU, an AP, a CP, a SoC, or an IC sensor hub, an auxiliary processor, a communication processor, an application processor, an ASIC, or an FPGA, and may have a plurality of cores.

According to an embodiment, the transceiver 2030 may support wired or wireless communication between the server 2000 and an external electronic device (e.g., the home appliance 1900). The wireless communication scheme may include, e.g., an LTE scheme, a 5G NR scheme, a Wi-Fi scheme, Bluetooth, Bluetooth low energy, infrared data association (IrDA), ultra-wideband (UWB), and near-field communication (NFC).

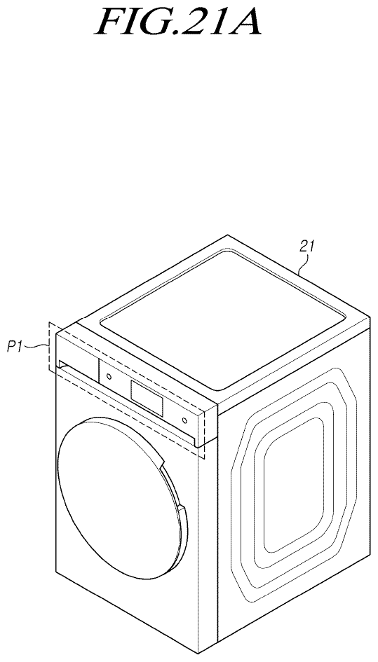

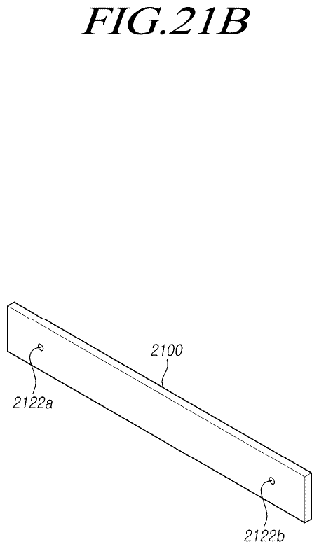

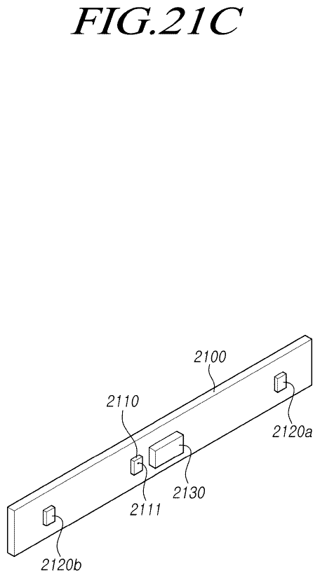

FIG. 21A illustrates an arrangement structure of a sensor assembly of a home appliance according to an embodiment of the disclosure. FIG. 21B is a front perspective view illustrating a sensor assembly according to an embodiment of the disclosure. FIG. 21C is a rear perspective view illustrating a sensor assembly according to an embodiment of the disclosure.

The sensor assembly 2100 of FIGS. 21A, 21B, and 21C may be, e.g., an example of the sensor assembly 800 of FIG. 8.

In the embodiment of FIG. 21A, the home appliance 21 (e.g., the home appliance 400 of FIG. 4, the home appliance 400a of FIG. 8, the home appliance 400b of FIG. 9, the home appliance 400c of FIG. 10, the home appliance 1600 of FIG. 16, or the home appliance 1900 of FIG. 19) may be, e.g., a washer having a closed internal space.

Referring to FIG. 21A, the sensor assembly 2100 may be disposed inside the front upper end portion (portion P1) of the housing of the washer.

Referring to FIGS. 21B and 21C, the sensor assembly 2100 may include at least one first sensor (e.g., one first sensor 2110), at least one second sensor (e.g., two second sensors 2120a and 2120b), and/or a connector 2130.

According to an embodiment, the first sensor 2110, the second sensors 2120a and 2120b, and/or the connector 2130 may be disposed on a printed circuit board (e.g., the printed circuit board 830 of FIG. 3, the printed circuit board 930 of FIG. 9, or the printed circuit board 1030 of FIG. 10) of the sensor assembly 2100.

According to an embodiment, the first sensor 2110 may be disposed adjacent to the other end of the first passage 2111 having one end open toward the inside of the home appliance 21. According to an embodiment, the second sensor 2120a and 2120b may be disposed adjacent to the other end of the second passage 2122a and 2122b having one end open toward the outside of the home appliance 21. As illustrated in FIG. 21A, the one end of the second passage 2122a and 2122b may correspond to an opening in the front upper front portion of the housing of the washer.

According to an embodiment, the sensor assembly 2100 may be connected to an external component (e.g., the main-processing module) of the sensor assembly 2130 through the connector 2130.

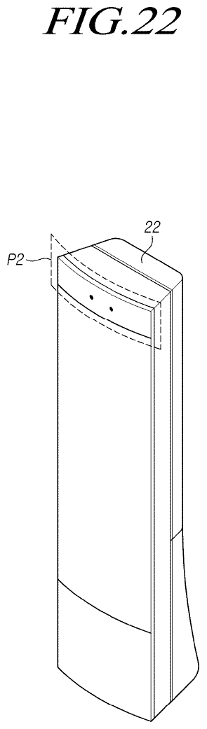

FIG. 22 illustrates an arrangement structure of a sensor assembly of a home appliance according to an embodiment of the disclosure.

The sensor assembly of FIG. 22 may be an example of the sensor assembly 900 of FIG. 9.

In the embodiment of FIG. 22, the home appliance 22 may be, e.g., an air conditioner having an open internal space.

Referring to FIG. 22, the sensor assembly may be disposed inside the front upper end portion (portion P2) of the housing of the air conditioner. The structure of the sensor assembly may be, e.g., the structure of the sensor assembly 2100 illustrated in FIGS. 21B and 21C.

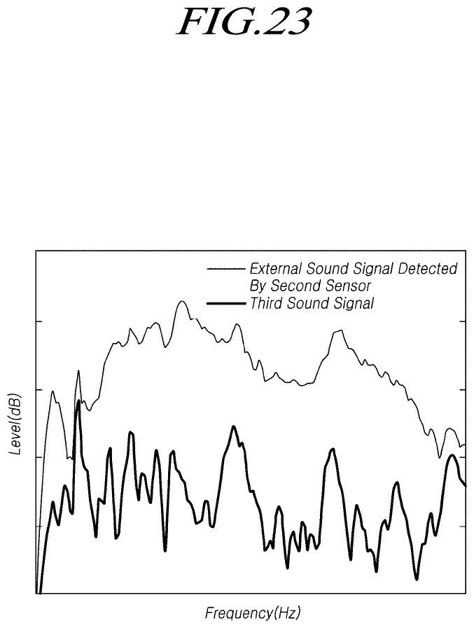

FIG. 23 illustrates a result of comparison between sound signals according to an embodiment of the disclosure.

The embodiment of FIG. 23 shows, e.g., a comparison between a second sound signal (external sound signal) detected by a second sensor (e.g., the second sensor 820 of FIG. 8) and a third sound signal pre-processed by a pre-processing module (e.g., the pre-processing module 410 of FIG. 4, the pre-processing module 410a of FIG. 5, the pre-processing module 410b of FIG. 6, or the pre-processing module 410c of FIG. 7) in a home appliance (e.g., the home appliance 400a of FIG. 8 or the home appliance 21 of FIG. 21A) having a closed internal space. Referring to FIG. 23, it may be identified that the external sound signal is removed or reduced in the pre-processed third sound signal.

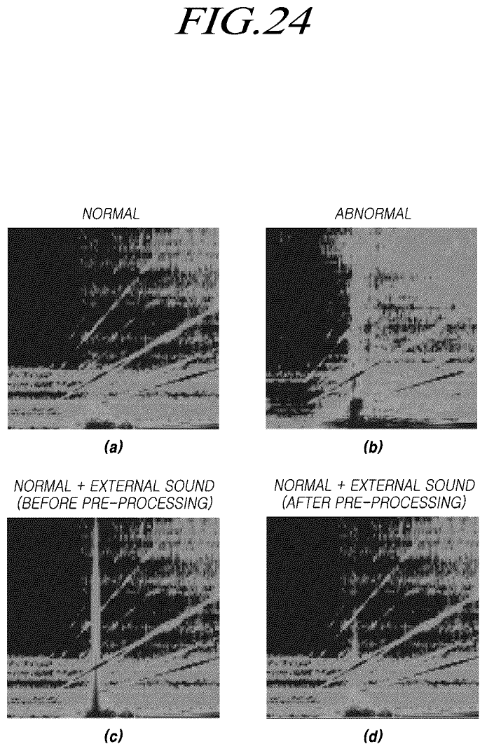

FIG. 24 illustrates a signal spectrum depending on a status of a home appliance according to an embodiment of the disclosure.

(a) of FIG. 24 illustrates a signal spectrum of a sound signal in a state in which the home appliance is normal, and (b) of FIG. 24 illustrates a signal spectrum of a sound signal in a state in which the home appliance is abnormal.

(b) of FIG. 24 illustrates a spectrum of a sound signal (i.e., a sound signal including an external sound) that is not pre-processed by a pre-processing module (e.g., the pre-processing module 410 of FIG. 4, the pre-processing module 410a of FIG. 5, the pre-processing module 410b of FIG. 6, or the pre-processing module 410c of FIG. 7), although the home appliance is normal. In this case, as illustrated, even though the home appliance is normal, the signal spectrum of the corresponding sound signal is similar to the spectrum of the signal in which the home appliance is abnormal due to external noise. Accordingly, when the status of the home appliance is diagnosed using the corresponding sound signal, the home appliance misdiagnoses the status of the home appliance as abnormal.

(d) of FIG. 24 illustrates a spectrum of a sound signal (i.e., an external sound-filtered third sound signal) pre-processed by a pre-processing module (e.g., the pre-processing module 410 of FIG. 4, the pre-processing module 410a of FIG. 5, the pre-processing module 410b of FIG. 6, or the pre-processing module 410c of FIG. 7), when the home appliance is normal. In this case, as illustrated, the signal spectrum of the corresponding sound signal is similar to the spectrum of the signal when the home appliance is normal. Accordingly, when the status of the home appliance is diagnosed using the corresponding sound signal, the home appliance correctly diagnoses the status of the home appliance as normal. As such, when pre-processing of the pre-processing module is performed, a status diagnosis system robust to external noise may be implemented.

According to an embodiment, a home appliance may comprise a sensor assembly including a first sensor and a second sensor for detecting a sound, a memory including at least one storage medium storing instructions, and at least one processor including a processing circuit.

According to an embodiment, the at least one processor may obtain a first sound signal including a signal corresponding to an operation sound generated inside the home appliance and a signal corresponding to an external sound generated outside the home appliance, using the first sensor.

According to an embodiment, the at least one processor may obtain a second sound signal using the second sensor. The second sound signal may include a signal having a correlation with the signal corresponding to the external sound of the home appliance included in the first sound signal.

According to an embodiment, the at least one processor may generate a third sound signal by performing pre-processing on the first sound signal and the second sound signal using an adaptive filter.

According to an embodiment, the at least one processor may obtain data related to a status of the home appliance based on the third sound signal.

According to an embodiment, a filter coefficient of the adaptive filter may be updated using a preconfigured adaptive algorithm based on the third sound signal and the second sound signal.

According to an embodiment, the first sensor may be disposed adjacent to another end of a first passage one end of which is open toward an inside of the home appliance, and the second sensor may be disposed adjacent to another end of a second passage one end of which is open toward an outside of the home appliance.

According to an embodiment, the first sensor may be disposed adjacent to another end of a first passage one end of which is open toward a boundary space between the inside and the outside of the home appliance, the second sensor may be disposed adjacent to another end of a second passage one end of which is open toward the boundary space, and the first passage may be disposed closer to the inside of the home appliance than the second passage is.

According to an embodiment, the at least one processor may be configured to generate a pre-filtered first sound signal by pre-filtering the first sound signal, generate a pre-filtered second sound signal by pre-filtering the second sound signal, generate a filtered second sound signal by filtering the pre-filtered second sound signal using the adaptive filter, and generate the third sound signal based on the pre-filtered first sound signal and the filtered second sound signal.

According to an embodiment, the adaptive filter may be a finite impulse response (FIR) filter, and the adaptive algorithm may be a least mean squared (LMS) algorithm. The filter coefficient of the adaptive filter may be updated by Equation A:

w←w−μxe [Equation A]
wherein w may be the filter coefficient, may be a step size of the adaptive filter, x may be the pre-filtered second sound signal, and e may be the third sound signal.

According to an embodiment, the at least one processor may be configured to generate a pre-filtered first sound signal by pre-filtering the first sound signal using a pre-filter, generate a fourth sound signal using the pre-filtered first sound signal and the second sound signal, generate a filtered fourth sound signal by filtering the fourth sound signal using the adaptive filter, and generate the third sound signal using the first sound signal and the filtered fourth sound signal.

According to an embodiment, the adaptive filter may be an FIR filter, and the adaptive algorithm may be an LMS algorithm. The filter coefficient of the adaptive filter may be updated by Equation B:

w←w−μze[Equation B]
wherein w may be the filter coefficient, may be a step size of the adaptive filter, z may be the fourth sound signal, and e may be the third sound signal.

According to an embodiment, the sensor assembly may include a housing and a first printed circuit board disposed in the housing and having the first sensor and the second sensor disposed thereon. The at least one processor may include a first processor disposed on the first printed circuit board and a second processor disposed on a second printed circuit board disposed outside the sensor assembly. The third sound signal may be generated by the first processor and is transferred to the second processor. The first sound signal and the second sound signal may not be transferred to the second processor.

According to an embodiment, data related to the status of the home appliance may include feature data for diagnosing the status of the home appliance or diagnosis result data obtained based on the feature data. The diagnosis result data may include at least one of first result data including a result of diagnosing the status of the home appliance based on the feature data or second result data including a result of comprehensively determining the status of the home appliance based on the first result data.

According to an embodiment, the home appliance may further comprise a transceiver. The at least one processor may be configured to transmit the data related to the status of the home appliance to a server using the transceiver. The server may generate the diagnosis result data based on the feature data and update status information about the home appliance based on the diagnosis result data when the data related to the status of the home appliance includes the feature data and, when the data related to the status of the home appliance includes the diagnosis result data, update the status information about the home appliance based on the diagnosis result data.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A home appliance, comprising:
a first sensor for detecting a sound;
a second sensor for detecting a sound;
memory including at least one storage medium storing instructions; and
at least one processor including a processing circuit, wherein the at least one processor is configured to execute the instructions to:
obtain a first sound signal using the first sensor, the first sound signal including a signal corresponding to an operation sound generated inside of the home appliance and a signal corresponding to an external sound generated outside of the home appliance,
obtain a second sound signal using the second sensor, the second sound signal including a signal having a correlation with the signal corresponding to the external sound generated outside of the home appliance included in the first sound signal,
generate a third sound signal by performing processing on the first sound signal and the second sound signal and using an adaptive filter with an input that is based on at least one of the first sound signal and the second sound signal, and
obtain data related to a status of the home appliance based on the third sound signal, wherein a filter coefficient of the adaptive filter is updated using an adaptive algorithm based on the third sound signal and the second sound signal.

2. The home appliance of claim 1, wherein
the home appliance has a first passage of which one end is open toward the inside of the home appliance, and the first sensor is adjacent to another end of the first passage, and
the home appliance has a second passage of which one end is open toward the outside of the home appliance, and the second sensor is adjacent to another end of the second passage.

3. The home appliance of claim 1, wherein
the home appliance has a first passage of which one end is open toward a boundary space between the inside of the home appliance and the outside of the home appliance, and the first sensor is adjacent to another end of the first passage,
the home appliance has a second passage of which one end is open toward the boundary space, and the second sensor is adjacent to another end of the second passage, and
the first passage is closer to the inside of the home appliance than the second passage is to the inside of the home appliance.

4. The home appliance of claim 1, wherein the at least one processor is configured to execute the instructions to:
generate a pre-filtered first sound signal by pre-filtering the first sound signal,
generate a pre-filtered second sound signal by pre-filtering the second sound signal,
generate a filtered second sound signal by filtering the pre-filtered second sound signal using the adaptive filter, and
generate the third sound signal based on the pre-filtered first sound signal and the filtered second sound signal.

5. The home appliance of claim 4, wherein the adaptive filter is a finite impulse response (FIR) filter, the adaptive algorithm is a least mean squared (LMS) algorithm, and the filter coefficient of the adaptive filter is updated by Equation 1:
$$w ← w - μ xe \qquad [ Equation 1 ]$$
wherein w is the filter coefficient, is a step size of the adaptive filter, x is the pre-filtered second sound signal, and e is the third sound signal.

6. The home appliance of claim 1, wherein the at least one processor is configured to execute the instructions to:
generate a pre-filtered first sound signal by pre-filtering the first sound signal using a pre-filter,
generate a fourth sound signal using the pre-filtered first sound signal and the second sound signal,
generate a filtered fourth sound signal by filtering the fourth sound signal using the adaptive filter, and
generate the third sound signal using the first sound signal and the filtered fourth sound signal.

7. The home appliance of claim 6, wherein the adaptive filter is an FIR filter, the adaptive algorithm is an LMS algorithm, and the filter coefficient of the adaptive filter is updated by Equation 2:
$$w ← w - μ ze \qquad [ Equation 2 ]$$
wherein w is the filter coefficient, is a step size of the adaptive filter, z is the fourth sound signal, and e is the third sound signal.

8. The home appliance of claim 1, further comprising:
a sensor assembly including a housing and a first printed circuit board in the housing,
wherein
the first sensor and the second sensor are on the first printed circuit board,
the at least one processor includes a first processor on the first printed circuit board and a second processor on a second printed circuit board that is outside the sensor assembly,
the third sound signal is generated by the first processor and is transferred to the second processor, and
the first sound signal and the second sound signal are not transferred to the second processor.

9. The home appliance of claim 1, wherein
the data related to the status of the home appliance includes feature data for diagnosing the status of the home appliance or diagnosis result data obtained based on the feature data, and
the diagnosis result data includes at least one of first result data including a result of diagnosing the status of the home appliance based on the feature data or second result data including a result of comprehensively determining the status of the home appliance based on the first result data.

10. The home appliance of claim 9, further comprising:
a transceiver,
wherein the at least one processor is configured to execute the instructions to transmit the data related to the status of the home appliance to a server, and
wherein the server is configured to:
in case that the data related to the status of the home appliance includes the feature data, generate the diagnosis result data based on the feature data and update status information about the home appliance based on the diagnosis result data and,
in case that the data related to the status of the home appliance includes the diagnosis result data, update the status information about the home appliance based on the diagnosis result data.

11. A method for operating a home appliance, the home appliance including a first sensor for detecting a sound and a second sensor for detecting a sound, the method comprising:
obtaining, using the first sensor, a first sound signal including a signal corresponding to an operation sound generated inside of the home appliance and a signal corresponding to an external sound generated outside of the home appliance;
obtaining, using the second sensor, a second sound signal including a signal having a correlation with the signal corresponding to the external sound generated outside of the home appliance included in the first sound signal;
generating a third sound signal by performing processing on the first sound signal and the second sound signal and using an adaptive filter with an input that is based on at least one of the first sound signal and the second sound signal; and
obtaining data related to a status of the home appliance based on the third sound signal, wherein a filter coefficient of the adaptive filter is updated using an adaptive algorithm based on the third sound signal and the second sound signal.

12. The method of claim 11, wherein
the home appliance has a first passage of which one end is open toward the inside of the home appliance, and the first sensor is adjacent to another end of the first passage, and
the home appliance has a second passage of which one end is open toward the outside of the home appliance, and the second sensor is adjacent to another end of the second passage.

13. The method of claim 11, wherein
the home appliance has a first passage of which one end is open toward a boundary space between the inside of the home appliance and the outside of the home appliance, and the first sensor is adjacent to another end of the first passage,
the home appliance has a second passage of which one end is open toward the boundary space, and the second sensor is adjacent to another end of the second passage, and
the first passage is closer to the inside of the home appliance than the second passage is to the inside of the home appliance.

14. The method of claim 11, wherein generating the third sound signal includes:
generating a pre-filtered first sound signal by pre-filtering the first sound signal,
generating a pre-filtered second sound signal by pre-filtering the second sound signal,
generating a filtered second sound signal by filtering the pre-filtered second sound signal using the adaptive filter, and
generating the third sound signal based on the pre-filtered first sound signal and the filtered second sound signal.

15. The method of claim 14, wherein the adaptive filter is an FIR filter, the adaptive algorithm is an LMS algorithm, and the filter coefficient of the adaptive filter is updated by Equation 1:
$$w ← w - μ xe \qquad [ Equation 1 ]$$
wherein w is the filter coefficient, is a step size of the adaptive filter, x is the pre-filtered second sound signal, and e is the third sound signal.

16. The method of claim 11, wherein generating the third sound signal includes:
generating a pre-filtered first sound signal by pre-filtering the first sound signal using a pre-filter,
generating a fourth sound signal using the pre-filtered first sound signal and the second sound signal,
generating a filtered fourth sound signal by filtering the fourth sound signal using the adaptive filter, and
generating the third sound signal using the first sound signal and the filtered fourth sound signal.

17. The method of claim 16, wherein the adaptive filter is an FIR filter, the adaptive algorithm is an LMS algorithm, and the filter coefficient of the adaptive filter is updated by Equation 2:
$$w ← w - μ ze \qquad [ Equation 2 ]$$
wherein w is the filter coefficient, is a step size of the adaptive filter, z is the fourth sound signal, and e is the third sound signal.

18. The method of claim 11, wherein
the home appliance includes a sensor assembly and at least one processor,
the sensor assembly includes a housing and a first printed circuit board in the housing,
the first sensor and the second sensor are on the first printed circuit board,
the at least one processor includes a first processor on the first printed circuit board and a second processor on a second printed circuit board that is outside the sensor assembly,
the third sound signal is generated by the first processor and is transferred to the second processor, and
the first sound signal and the second sound signal are not transferred to the second processor.

19. The method of claim 11, wherein
the data related to the status of the home appliance includes feature data for diagnosing the status of the home appliance or diagnosis result data obtained based on the feature data, and
the diagnosis result data includes at least one of first result data including a result of diagnosing the status of the home appliance based on the feature data or second result data including a result of comprehensively determining the status of the home appliance based on the first result data.

20. The method of claim 19, wherein the home appliance includes a transceiver, and the method further comprises:
transmitting the data related to the status of the home appliance to a server using the transceiver, and
wherein the server is configured to:
in case that the data related to the status of the home appliance includes the feature data, generate the diagnosis result data based on the feature data and update status information about the home appliance based on the diagnosis result data and,
in case that the data related to the status of the home appliance includes the diagnosis result data, update the status information about the home appliance based on the diagnosis result data.
